(19) United States
(12) Patent Application Publication
(10) Pub. No.: US 2026/0285600 A1
(43) Pub. Date: Sep. 24, 2026

(54) TRANSPORT VEHICLE, TRANSFER STATION, WORKSTATION FOR OPTIMIZED LOADING OF LOADING DEVICES, AND ORDER-PICKING SYSTEM

(71) Applicant: TGW Logistics GmbH, Marchtrenk (AT)

(72) Inventors: Eugen BAUMANN, Linz (AT); Josef REISCHL, Gunskirchen (AT); Michael TEICHMEISTER, Oftering (AT); Ramón MARTÍNEZ VALDIVIA, Madrid (ES); Alberto SANCHIS SEBASTIÁ, Linz (AT); Gerald KETTLGRUBER, Linz (AT)

(73) Assignee: TGW Logistics GmbH, Marchtrenk (AT)

(21) Appl. No.: 19/474,268

(22) PCT Filed: Apr. 13, 2024
(86) PCT No.: PCT/AT2024/060148

§ 371 Date: Oct. 24, 2025

(30) Foreign Application Priority Data
Apr. 14, 2023 (AT) A50274/2023
Mar. 4, 2024 (AT) A50183/2024

(51) Int. Cl. B65G 1/137; B66F 9/065; G05D 1/244; G05D 1/667; G05D 105/28; G05D 107/70

(52) U.S. Cl. CPC B65G 1/1378; B66F 9/065; G05D 1/667; G05D 1/244; G05D 2105/28; G05D 2107/70

(57) ABSTRACT

A driverless transport vehicle has a support frame, a chassis, a controller and a loading platform with a base permanently fixed on the support frame and inclined by an angle of inclination in relation to a horizontal plane. Furthermore, a handover station for transferring a loading aid between the transport vehicle and a receiving location has a parking location for the transport vehicle as well as a transfer device with a pusher movable relative to the receiving location for moving the loading aid. In addition, in a workstation for loading loading aids on transport vehicles with articles, a first conveying system for articles and a second driving surface for the transport vehicles form a passageway for transport vehicles each loaded with a loading aid. Finally, in an order-picking system, the transport vehicles, a handover station and/or a workstation of the types stated are used.

The invention relates to a driverless transport vehicle, in particular for transporting a loading aid, comprising a support frame and a chassis mounted on the support frame, wherein the chassis has a plurality of wheels and is configured to drive and steer the driverless transport vehicle. The transport vehicle further comprises a controller configured to receive drive commands and to control the driverless transport vehicle. Finally, the transport vehicle comprises a loading platform mounted on the support frame.

Moreover, the invention relates to a handover station for automatically transferring a loading aid between the loading platform of a driverless transport vehicle and a receiving location, in particular on a conveying system. The handover station comprises a driverless transport vehicle of the aforementioned type, a parking location for the driverless transport vehicle, at which the driverless transport vehicle is positionable in such a way that the loading platform of the driverless transport vehicle is aligned with the receiving location, and a transfer device with a pusher movable relative to the receiving location and along a guide by a drive device. The pusher is configured to push a loading aid from the loading platform of the driverless transport vehicle onto the receiving location and/or to push a loading aid from the receiving location onto the loading platform of the driverless transport vehicle when the loading platform of the driverless transport vehicle is aligned with the receiving location.

The invention further relates to a workstation for loading loading aids with articles according to orders, in particular picking orders, comprising an order management system for the electronic acquisition of orders, a first provisioning device for providing articles, a first and a second conveying system, and a first to third driving surface. The first conveying system connects a transfer zone and the first provisioning device and is configured to transport the articles between the transfer zone and the first provisioning device. The second conveying system comprises driverless transport vehicles for transporting the loading aids. The first driving surface comprises a first and second driving surface section, the second driving surface comprises a second provisioning device for providing loading aids with the driverless transport vehicles at a second provisioning position, and the third driving surface is arranged between the first driving surface and the second driving surface.

The invention also relates to an order-picking system for picking articles, comprising a storage zone with storage places for providing articles and a picking zone for processing orders, wherein a workstation of the aforementioned type is arranged in the picking zone.

Furthermore, the invention relates to an order-picking system for picking articles, comprising a storage zone with storage places for providing articles and a picking zone, wherein a workstation for loading loading aids with articles is arranged in the picking zone. Moreover, the order-picking system comprises a first conveying system for transporting articles and a second conveying system for transporting loading aids, wherein the second conveying system comprises driverless transport vehicles. The transportation of articles by the first conveying system comprises a transportation of articles from a transfer zone to a first provisioning device at the workstation. The transportation of loading aids by the driverless transport vehicles comprises a transportation of loading aids from a handover station, which can be configured as described above, to a second provisioning device at the workstation, as well as a transportation of loading aids from the workstation to a handover station, which can also be configured as described above. Finally, the order-picking system comprises a handover station for transferring a loading aid from a receiving location of the handover station onto a loading platform of a driverless transport vehicle and a handover station for transferring a loading aid from a loading platform of a driverless transport vehicle onto a receiving location of the handover station, wherein at least one of the handover stations is configured as described above.

The invention also relates to a method for loading loading aids with articles according to orders, in particular picking orders, at a workstation of the aforementioned type.

A transport vehicle, a handover station, a workstation and an order-picking system of the respective aforementioned types are fundamentally known in the prior art. In the context of the transport vehicle, the disadvantages of the prior art are particularly the transferring of a loading aid between a loading platform of the transport vehicle and a receiving location on a conveying system. Workstations according to the prior art require a comparatively large floor area. Moreover, extensions are often only realizable with great (reconstruction) effort. Finally, the optimization of known order-picking systems with respect to their required installation space and performance is complex.

One object of the invention is thus to provide an improved transport vehicle, an improved handover station, an improved workstation, an improved order-picking system and an improved method for loading loading aids with articles. In particular, a transport vehicle is proposed which facilitates transferring a loading aid with a technically simple transport vehicle construction. The handover station seeks to enable a loading and/or unloading of the transport vehicle with a technically simple handover station construction. In connection with the workstation, in particular a solution is proposed which enables an ergonomic loading of a loading aid on a transport vehicle with a particularly compact and modular construction of the workstation. Finally, in particular an order-picking system is proposed in which at least part of the aforementioned components are advantageously combined.

The object of the invention is solved by a driverless transport vehicle of the type mentioned at the beginning, in which the loading platform comprises a base which is permanently fixed on the support frame and is inclined by an angle of inclination in relation to a horizontal plane. The loading platform can receive a loading aid. The loading aid is supported on the base when the loading aid is placed on the loading platform. Fundamentally, also more than one loading aid can be received on the loading platform. The loading aids are supported on the base when the loading aids are placed on the loading platform. For example, loading aids can be received next to and/or behind one another on the loading platform.

The proposed measures enable loading and unloading of a transport vehicle and/or a loading aid positioned thereon with a technically simple transport vehicle construction. The advantages according to the invention are achieved in particular with container-shaped loading aids. Tilting mechanisms, which render a transport vehicle technically complex and prone to errors, are not necessary.

The driverless transport vehicles are in particular floor-conveying, driverless transport vehicles, which are preferably autonomously drivable. Such driverless transport vehicles are also referred to as “Automated Guided Vehicles (AGV)” or “Autonomous Mobile Robots (AMR)”.

In the case of “Automated Guided Vehicles (AGV)”, an optical or magnetic driving path marking is used which the transport vehicle can detect and follow using sensors. The driving path marking is arranged in the region of the first driving surface, in the region of the second driving surface and/or in the region of the third driving surface.

A driving path marking is not necessary for “Autonomous Mobile Robots (AMR)” and the “Autonomous Mobile Robots (AMR)” can navigate without collision in the vicinity of the driving surface. For this purpose, the “Autonomous Mobile Robots (AMR)” comprise sensors and a computer is used for route planning.

“Lanes” for the AGVs can be physically applied on the first, second and/or third driving surfaces, for instance in the form of optical or magnetic driving path markings.

AMRs are fundamentally freely movable, although they can also follow lanes. These can, for example, be provided virtually in a digital representation of the respective driving surface. Control of the AMRs can be performed in particular according to the digital twin concept, where, for example, the digital twins of the AMRs follow the digital or virtual lanes and thus occasion a corresponding movement of the physical AMRs along the lanes in the real world.

The chassis of the transport vehicle can, for example, comprise one or more drive motors, one or more drive shafts, bearings for the wheels, and optionally one or more steering motors and the like. Preferably, steering of the driverless transport vehicle is achieved through differential speed control of the wheels, wherein the wheels are drive wheels according to such an embodiment. Each drive wheel is driven with a different speed in order to rotate the transport vehicle about its vertical axis. By contrast, to drive forwards or backwards, the two drive motors are driven with the same speed. Alternatively, steering wheel control is also possible. In the case of steered wheel control, the drive wheel is preferably the wheel that steers.

Furthermore, the object of the invention is solved by a handover station for automatically transferring a loading aid between the loading platform of a driverless transport vehicle and a receiving location, in particular on a conveying system, or by an automatic loading and/or unloading of a loading platform of a driverless transport vehicle of the type mentioned at the beginning, whereby the transport vehicle has the aforementioned features (i.e., in which the loading platform comprises a base is permanently fixed on the support frame and inclined by an angle of inclination in relation to a horizontal plane).

The proposed measures enable a loading and/or unloading of a transport vehicle in a comparatively simple manner. In particular, the loading and/or unloading can be performed at high capacity. The handover station has a technically simple construction and is thus not prone to errors. The loading and/or unloading of the transport vehicle is performed by a simple pushing (without lifting) of a loading aid onto the (inclined) base of the loading platform of the transport vehicle. The loading of the transport vehicle thereby comprises a pushing (without lifting) of a loading aid from a receiving location onto the (inclined) base of the loading platform of the transport vehicle. The unloading of the transport vehicle thereby comprises a pushing (without lifting) of a loading aid from the (inclined) base of the loading platform of the transport vehicle onto a receiving location. The pushing during loading and/or unloading can be performed without or with the pusher of the handover station.

Moreover, the object of the invention can be solved by a workstation of the type mentioned at the beginning,
wherein the first conveying system is arranged in a conveying section facing the first provisioning device and the second driving surface is arranged with a vertical spacing to the first driving surface, and a passageway is configured below the first conveying system and the second driving surface, along which passageway the first driving surface section extends and which has a clearance height (and clearance width) which enables a collision-free movement of the transport vehicles each loaded with a loading aid, and
wherein the workstation comprises a control unit for controlling the first conveying system and the transport vehicles in such a way that an article transported by the first conveying system, and a loading aid transported by one of the transport vehicles, of an order arrive approximately simultaneously at the first and second provisioning positions, whereupon the loading aid can be loaded with the article.

The proposed measures enable an ergonomic loading of a loading aid and an efficient picking of articles with a particularly compact and modular construction of the workstation. The loading aid is placed on the loading platform of a transport vehicle and is held in the provisioning position by the transport vehicle during the loading process.

The first driving surface and the second driving surface are arranged at different height levels. The first driving surface and/or second driving surface is preferably a horizontal driving surface. The second provisioning device is thus provided on the horizontal driving surface.

The driverless transport vehicles, of the aforementioned type, can be moved on the first driving surface and second driving surface.

The third driving surface connects the first driving surface and second driving surface and extends obliquely or has a ramp-like configuration. The driverless transport vehicles, of the aforementioned type, can be moved on the third driving surface. The gradient of the second driving surface is between 5° and 15°, for example 10°.

The passageway allows the loaded transport vehicles to use the space below the first conveying system and the second, and where applicable third, driving surfaces of the second conveying system. This also contributes to a compact construction of the workstation. By positioning a plurality of workstations in a row, a group of workstations can be formed, the size of which can be simply adjusted to a predetermined capacity requirement.

In particular, the transport vehicles of the workstation can be configured as described above, whereby a particularly simple loading of the loading aids provided by the transport vehicles can be enabled.

According to a first embodiment, the workstation comprises a working location for a warehouse worker for manually loading the loading aids with an article, wherein the loading aids are provided with the transport vehicles (preferably one after the other) at the second provisioning position, which is assigned to the second provisioning device. The article is provided at the first provisioning position, which is assigned to the first provisioning device. It is thereby advantageous for the first provisioning device and the second provisioning device to be configured to provide an article and a loading aid at an ergonomic provisioning height for manual loading.

For the purposes of manual order processing, the workstation comprises an input and/or output device connected with the control unit.

The output device is configured to receive loading instructions from the control unit and to issue them to a warehouse worker working in the working location. For example, the number of articles to be loaded into a loading aid is stated. If a plurality of loading aids are provided at the same time at the second provisioning positions, an instruction can be issued as to which loading aid is to be loaded with articles. The output device comprises, for example, a touchscreen, a loudspeaker and the like.

The input device is configured to receive an input command and to transmit a control signal to the control unit. An input command is triggered by a confirm button, for instance. For example, the warehouse worker can confirm the completion of a loading process by pressing the confirm button. The input device comprises, for example, a confirm button, a switch and the like. An input and output device thus has features both of an input device and of an output device.

According to a second embodiment, the workstation comprises a loading robot at the working location for an automatic loading of the loading aids with an article, wherein the loading aids are, however, provided with the transport vehicles (preferably one after the other) at the second provisioning position, which is assigned to the second provisioning device. In contrast, the article is provided at the first provisioning position, which is assigned to the first provisioning device.

The article can be transported by the first conveying system between the transfer zone and the first provisioning device either without loading aid or with loading aid. The loading aids of the first conveying system can, for example, be provided as a container, tray, box or the like.

The first provisioning device for providing articles can comprise one provisioning position or a plurality of provisioning positions. Each provisioning position is assigned to an article. The provisioning device serves to provide articles either without loading aid or with loading aid.

It should also be noted here that the article can be transported by the third conveying system in the storage zone and/or between the storage zone and the transfer zone, either without loading aid or with loading aid. Likewise, the article can be stored in the storage zone either without loading aid or with loading aid.

The loading aids (which are assigned to the first conveying system, the third conveying system and/or the storage zone) can, for example, be provided as a container, tray, box or the like.

If the article is transported with a loading aid of the first conveying system, the article is stored in the loading aid. Such a loading aid is also referred to as a source loading aid. The first conveying system can comprise stationary (permanently installed or permanently suspended) conveying devices, for example roller conveyors, belt conveyors and the like.

The second provisioning device for providing loading aids can comprise one provisioning position or a plurality of provisioning positions. Each provisioning position is assigned to a loading aid.

The loading aids of the second conveying system can, for example, be provided as a container, tray, box or the like. Such a loading aid is also referred to as a target loading aid. The loading aids are preferably designed as boxes intended for shipping.

In particular, the control unit can be configured to control the following steps:
i) transport the article to the first provisioning device using the first conveying system,
ii) provide the article at the first provisioning position,
iii) transport a loading aid to the second provisioning device using a (autonomously movable) driverless transport vehicle, wherein the transport vehicle is moved from the third driving surface to the second driving surface and on the second driving surface to the second provisioning device,
iv) provide the loading aid at the second provisioning position,
v) load the loading aid provided in step iv) with an article provided in step ii) according to an order,
vi) following step v), transport the loading aid loaded with an article from the second provisioning position using a (autonomously movable) driverless transport vehicle, wherein the transport vehicle is moved from the second provisioning device on the second driving surface to the third driving surface. The control unit controls the first conveying system and the transport vehicles in such a way that an article transported by the first conveying system, and a loading aid transported by one of the transport vehicles, of an order arrive approximately simultaneously at the first and second provisioning positions.

A clearance width of the passageway can be dimensioned such that it corresponds at least to a width of a transport vehicle. Preferably, the clearance width corresponds to a width of a transport vehicle loaded with a loading aid. A clearance width of the passageway can also be dimensioned such that it corresponds to two transport vehicles moving one next to the other. Preferably, the clearance width corresponds to a width of two transport vehicles each loaded with a loading aid.

Finally, the object of the invention is solved by order-picking systems of the types mentioned at the beginning, in which the workstation and/or the handover station(s) have the aforementioned features.

The proposed measures combine the components outlined above in an advantageous manner, so that the capacity of an order-picking system can be increased over known order-picking systems with the same installation space.

It should be noted here that it is fundamentally also conceivable that an article, in particular a box, is removed from the first provisioning device and immediately placed on the base of the loading platform of a driverless transport vehicle. The driverless transport vehicle is provided at the second provisioning device, but without a loading aid.

Accordingly, the workstation can comprise the features listed in the following as an alternative or in addition to the workstation described above (according to claims 12 to 27).

A workstation for loading transport vehicles with articles according to orders, in particular picking orders, comprising
an order management system for the electronic acquisition of orders,
a first provisioning device for providing articles,
a first conveying system connecting a transfer zone and the first provisioning device and configured to transport the articles between the transfer zone and the first provisioning device,
a second conveying system comprising driverless transport vehicles for transporting the article,
a first driving surface comprising a first driving surface section and a second driving surface section,
a second driving surface comprising a second provisioning device for providing driverless transport vehicles,
a third driving surface arranged between the first driving surface and the second driving surface,
wherein the first conveying system is arranged in a conveying section facing the first provisioning device and the second driving surface is arranged with a vertical spacing to the first driving surface, and a passageway is configured below the first conveying system and the second driving surface, along which passageway the first driving surface section extends and which has a clearance height enabling a collision-free movement of the transport vehicles each loaded with a loading aid, and
a control unit controlling the first conveying system and the transport vehicles in such a way that an article and a transport vehicle of an order arrive approximately simultaneously at the first and second provisioning devices, whereupon the transport vehicle can be loaded with the article.

Further advantageous embodiments and developments of the invention can be derived from the dependent claims as well from the description in combination with the figures.

The loading platform of the transport vehicle can preferably be fixed on the support frame in such a way that a center of gravity of a loading aid is substantially in the proximity of a vertical axis through the center of gravity of the transport vehicle without loading platform.

According to an embodiment variation of the transport vehicle, the support frame comprises a front vehicle side and a rear vehicle side (relative to a driving direction of the driverless transport vehicle), wherein the base of the loading platform is inclined laterally by the angle of inclination in relation to a longitudinal axis extending between the front vehicle side and the rear vehicle side. A loading aid can thereby be provided without the driving direction of the transport vehicle having to be changed to move to a provisioning position and to leave the same. In addition, a loading aid cannot unintentionally fall off the loading platform so easily during acceleration or braking.

It is, however, also conceivable for the support frame to comprise a front vehicle side and a rear vehicle side (relative to a driving direction of the driverless transport vehicle) and for the base of the loading platform to be inclined rearwards or forwards by the angle of inclination in the direction of a longitudinal axis extending between the front vehicle side and the rear vehicle side. Advantageously, a loading aid cannot unintentionally fall off the loading platform so easily during movement around a corner.

It is favorable for the angle of inclination of the base of the loading platform to be in a range of 10° to 60°. In particular, the angle of inclination can be in a range of 10° to 20°. An angle of inclination of 12° is particularly advantageous. A loading aid located on the loading platform can thereby be provided in a favorable position for loading and/or unloading. Moreover, a loading aid at such an angle of inclination cannot unintentionally fall off the loading aid so easily during movement of the transport vehicle either. Furthermore, a drive device can be configured relatively small and the drive power for the pusher of a handover configured relatively low.

Advantageously, the transport vehicle can comprise a positioning unit mounted on the support frame, the former preventing an undesired shifting of a loading aid positioned on the loading platform if the loading aid is transported by the transport vehicle.

The positioning unit can comprise one or more engaging element(s), which are movable between a release position and a fixing position relative to the base of the loading platform. In the release position, a loading aid can be unloaded from the loading platform. In the fixing position, a loading aid can be held in position on the loading platform. For example, the engaging element can positively engage behind a loading aid.

It is advantageous for the loading platform of the transport vehicle to additionally comprise
a first stop element arranged in a lower lying side region of the base, protruding (upwards) in relation to the base, and
a handover section arranged in a higher lying side region of the base.

On the one hand, a loading aid positioned on the loading platform can thereby not unintentionally slide down off the loading platform, and on the other hand loading and/or unloading can be performed in a simple manner via the handover section. A loading aid is thereby pushed up onto the loading platform (without lifting) or pushed down from the same. Technically complex lifting and gripping devices are not required.

The first stop element limits a downward movement of the loading aid after the loading aid has been pushed onto the loading platform and the loading aid is moved in the direction of the first stop element on the inclined base due to gravity. The first stop element and the handover section preferably extend substantially parallel to one another.

It is also advantageous for the loading platform to additionally comprise
a second stop element arranged in a side region of the base extending between the lower lying side region of the base and the higher lying side region of the base, protruding (upwards) in relation to the base, and
a third stop element arranged in a side region of the base extending between the lower lying side region of the base and the higher lying side region of the base, protruding (upwards) in relation to the base.

That can thus prevent a loading aid from unintentionally falling off the loading platform sideways (i.e. transverse to a slope line of the base).

Preferably, the first, second and third stop elements each have a stop height optimized in such a way that a loading aid is reliably prevented from toppling over or falling off the loading platform of the transport vehicle, even if the transport vehicle is moved dynamically.

Furthermore, the second and third stop elements can serve as a guide to a loading aid during a pushing-up process in the handover station.

Preferably, the first, second and third stop elements each have the same stop height.

Moreover, it is favorable for the loading platform to additionally comprise a sliding support arranged in the higher-lying side region of the base, forming the handover section. That way, loading of the transport vehicle by pushing a loading aid up onto the loading platform and/or unloading by pushing a loading aid off the loading platform can be performed in a particularly simple manner.

In a further embodiment variation, the base of the transport vehicle comprises a base plate. Smaller loading aids in particular can thereby be reliably transported.

It is, however, also conceivable for the base of the transport vehicle to comprise support profiles. A loading platform with high stability and low weight can thereby be achieved. The support profiles preferably extend parallel to one another with a mutual spacing between the handover section and the first stop element. The support profiles can, for example, be U-shaped or C-shaped.

Furthermore, it is favorable for the base of the loading platform to provide a sliding plane. In particular, the sliding plane can stretch between the handover section and the first stop element and optionally between the second stop element and the third stop element. The proposed measures further simplify loading of the transport vehicle by pushing a loading aid onto the loading aid and/or unloading by pushing a loading aid off the loading platform. For example, a slide coating can be applied to the base.

It should be noted here that in the context of the invention, a loading aid is also to be understood as an article in connection with transportation by a driverless transport vehicle and the loading/unloading of the transport vehicle, insofar as the article is removed from the first provisioning device and immediately transferred to the loading platform of a driverless transport vehicle.

In an advantageous embodiment variation of the workstation, the first conveying system is arranged in a conveying section facing away from the first provisioning device at a vertical spacing to the first driving surface, and an additional passageway is arranged below the first conveying system, along which the second driving surface section extends and which has a clearance height (and clearance width) enabling a collision-free movement of the transport vehicles each loaded with a loading aid (of the second conveying system).

A clearance width of the additional passageway can be dimensioned such that it corresponds at least to a width of a transport vehicle. Preferably, the clearance width corresponds to a width of a transport vehicle loaded with a loading aid. A clearance width of the passageway can also be dimensioned such that it corresponds to two transport vehicles travelling next to one another. Preferably, the clearance width corresponds to a width of two transport vehicles each loaded with a loading aid.

In a favorable embodiment variation of the workstation, the transfer zone of the workstation can be provided to
transfer articles (with or without loading aid) to the first conveying system, or
to transfer articles (with or without loading aid) to the first conveying system and to transfer articles (with or without loading aid) from the first conveying system.

It is thereby possible to receive articles (with or without loading aid) at the workstation from a (third) conveying system and/or to transfer them to the latter, which can be configured differently to the first conveying system. For example, a first conveying system with stationary conveying devices can receive articles (with or without loading aid) from transport vehicles of the (third) conveying system or transfer them to the latter.

Furthermore, it is favorable for a first lane to extend along the first driving surface section and a second lane to extend along the second driving surface section. In this embodiment variation, the first driving surface section is configured so that the transport vehicles are moved along the first lane. The first lane can be configured as a one-way lane; the transport vehicles are then thus only moved in one direction. In this embodiment variation, the second driving surface section is configured so that the transport vehicles are moved along the second lane. The second lane can be configured as a one-way lane; the transport vehicles are then thus only moved in one direction. The movement directions of the transport vehicles on the first driving surface section and the second driving surface section are preferably opposing. It is also favorable for the first lane and the second lane to extend parallel to one another.

According to a possible embodiment, the first lane can form a closed circulation in the first driving surface section.

Likewise, the second lane can form a closed circulation in the second driving surface section.

In addition, the first lane and the second lane can together form a closed circulation.

Moreover, it is favorable for a changeover lane to extend between the first lane and the second lane and for it to be possible to move the transport vehicles on the first driving surface between the first driving surface section and the second driving surface section. The transport vehicles can thereby be exchanged between the first driving surface section and the second driving surface section.

According to a further possible embodiment, the changeover lane can comprise a first changeover lane and a second changeover lane, so that the first changeover lane, the first lane, the second changeover lane and the second lane form a closed circulation. The first changeover lane, the first lane, the second changeover lane and the second lane can thereby be configured as one-way. In this case, the transport vehicles are only moved in one direction.

It is particularly advantageous for
an approaching lane to diverge from the second lane and a returning lane to merge into the second lane,
the approaching lane to extend in a first driving surface section of the third driving surface,
the returning lane to extend in a second driving surface section of the third driving surface, and
a provisioning lane to extend between the approaching lane and the returning lane in a driving surface section of the second driving surface, wherein the provisioning lane is assigned to the second provisioning device.

A one-way system coupled to the second driving surface section can thereby achieved on the second and third driving surfaces. The transport vehicles can thus move largely without impeding each other on the second and third driving surfaces. The transport vehicles are then moved in a single direction along the approaching lane, provisioning lane and returning lane, wherein the approaching lane and the returning lane extend in particular parallel to one another.

It is also particularly advantageous for one or more sorting lanes to extend in a third driving surface section of the third driving surface between the approaching lane and the returning lane. In other words, each sorting lane diverges from the returning lane and merges into the approaching lane. The proposed measure allows for a sorting device comprising the second conveying system, to be configured on the third driving surface. Since at the same time the third driving surface serves to bridge the height difference between the first driving surface (in particular the second driving surface section) and the second driving surface, a multiple use of the third driving surface thus results, forming the basis for a particularly compact construction of the workstation or making a particular contribution thereto. It should be noted here that one or more sorting lanes can additionally be arranged on the second driving surface, also contributing to a compact construction of the workstation.

Furthermore, it is particularly advantageous for one or more express lanes to extend in the driving surface section of the second driving surface between the approaching lane and the returning lane. The express lane is similar to a sorting lane, but is located particularly close to the second provisioning device. As such, the express lane can be construed as a close or closest sorting lane to the second provisioning device. Thus, alternatively to a sorting lane, a transport vehicle can be moved along an express lane if a loading aid has to be provided promptly at the second provisioning position.

It is further advantageous for the first lane extending in the first driving surface section and the second lane extending in the second driving surface section to each have a coupling zone,
wherein the coupling zones are connectable with a further workstation, in particular one which is adjacent and has an identical construction.

Accordingly, a group can be formed out of a plurality of workstations comprising a plurality of workstations of the described type arranged one next to the other, wherein the first driving surface sections and second driving surface sections of the workstations are connected with one another. An order-picking system results which can be scaled almost at will.

In a further advantageous embodiment of the workstation, the control unit is additionally configured to control the first conveying system and the transport vehicles in such a way that the transport vehicles sort the loading aids into an order determined depending on the order in which the articles (with or without loading aid) are provided at the first provisioning device, and that a loading aid (hence target loading aid) and an article (with our without source loading aid) of an order arrive approximately simultaneously at the first provisioning position and the second provisioning position. Efficient loading or efficient picking can thereby also be ensured if the transport vehicles reach the third driving surface at an inconvenient moment and/or in an inconvenient order. For example, the loading aids can be sorted into an order using the transport vehicles by one of the transport vehicles diverging from the approaching lane into a sorting lane and another of the transport vehicles moving past the transport vehicle that has diverged into the sorting lane. The transport vehicle that diverged into the sorting lane can then be moved from the sorting lane into the approaching lane.

It is also advantageous for
an order of the orders to comprise a first order line and a second order line, wherein the first order line and second order line comprise articles of different article types, and for the control unit to be additionally configured for controlling such that
a loading aid for processing the first and second order lines is first transported by the transport vehicle from the second provisioning device via the returning lane into a sorting lane after loading of the loading aid with the article of the first order line and is buffered in the sorting lane, and thereafter the loading aid is transported from the sorting lane via the approaching lane to the second provisioning device when the article of the second order line is/has been transported to the first provisioning device by the first conveying device.

Particularly efficient loading of the loading aid or particularly efficient picking can thereby be achieved, even if the articles cannot be provided at the first provisioning device at the same time. This can be the case, for example, if articles of a single type are transported in different loading aids of the first conveying system, but only one first provisioning position or too few first provisioning positions is/are available.

Furthermore, it is advantageous for
a plurality of orders to comprise articles of the same article type,
a loading aid to be assigned to each order, and
the control unit to be additionally configured to control the loading of each of the loading aids assigned to the orders with an article of the same article type,
wherein the article is provided once at the first provisioning device and the loading aids are provided at the second provisioning device on one transport vehicle each.

Particularly efficient loading of (a plurality of) loading aids or particularly efficient picking can thereby also be achieved, even if a plurality of loading aids (or not all required loading aids to be loaded with articles of the same article type) cannot be provided at the second provisioning device at the same time. This can, for example, be the case if only one second provisioning position or too few second provisioning positions is/are available.

The loading aids can be provided at the second provisioning device one after the other on one transport vehicle each if a single second provisioning position is provided. The loading aids can, however, also be provided one next to the other on one transport vehicle each at the second provisioning device if a plurality of second (in particular sufficient second) provisioning positions are provided.

As previously described, the articles can be transported on the first conveying system with or without loading aids.

The first conveying system can comprise a first conveying device for transporting articles from the transfer zone to the first provisioning device and a second conveying device for transporting articles from the first provisioning device to the transfer zone. The first conveying system can also comprise a third conveying device comprising the first provisioning device and connects the first conveying device and the second conveying device. A one-way system for the articles can thus also be achieved in the first conveying system. If the articles are transported with loading aids, loading aids containing articles are transported by the first conveying device. Loading aids transported by the second conveying device can (still) contain articles, or not contain any. The latter is the case if all articles have been removed for processing an order.

The first conveying system can alternatively comprise a conveying device for transporting articles 12 from the transfer zone F to the first provisioning device 15 and for transporting articles 12 from the first provisioning device 15 to the transfer zone F.

In other words, the first conveying system can be configured
to transport articles from the transfer zone to the first provisioning device, or
to transport articles from the transfer zone to the first provisioning device and to transport articles from the first provisioning device to the transfer zone.

The first conveying device can, in particular, be configured as a stationary conveying system and thus be permanently installed.

Furthermore, it is favorable for the first conveying system to comprise a plurality of buffer locations and the control unit to be additionally configured to provide an article of different article type one after the other, wherein the article is buffered at the buffer locations. The buffer locations are similar in their function to the sorting lanes (or sorting spaces on the sorting lanes), however they are not necessarily arranged between the first conveying device and the second conveying device, but rather can also be assigned only to the first conveying device (if the articles have to be buffered during transportation to the first provisioning device) or be assigned only to the second conveying device (if the articles have to be buffered during transportation away from the first provisioning device). The buffer locations can also be used to provide articles sorted in a predeterminable order.

In this regard, it is also advantageous for the first conveying system to comprise a sorting buffer configured to provide articles sorted in an order. The sorting buffer comprises a plurality of buffer locations arranged along a first conveying device, and/or a plurality of sorting spaces arranged along a second conveying device, and a plurality of sorting conveying devices connecting the sorting spaces and buffer locations.

It can also prove advantageous for
the transport vehicle to be configured according to one of the above aspects,
a loading aid to be placeable on the base inclined by an angle of inclination in relation to a horizontal plane of the loading platform,
the loading aid to comprise a base, side walls projecting from the base, and a loading opening delimited by the side walls, and
the controller of the transport vehicle to perform a drive command in such a way that the transport vehicle is provided (stopped) at the second provisioning device in a pose in which the loading aid is aligned or provided in such a way (by the base of the loading platform) to the first provisioning device or to the article provided there that an edge of a front side wall of the side walls lies lower than an edge of a rear side wall of the side walls in order to enable ergonomic loading of the loading aid with the article via the loading opening.

Particularly ergonomic loading of the (target) loading aid is achieved. The loading can be performed manually by a warehouse worker or automatically by a robot. In the context of a manual loading process, “ergonomic” means that the warehouse worker still has good access to a loading space in the (target) loading aid and the loading movements can be kept short even where the (target) loading aid has high side walls. In the context of an automatic loading process, “ergonomic” means that the robot still has good access to a loading space in the (target) loading aid and the loading movements can be kept short even where the (target) loading aid has high side walls.

It can prove advantageous for the pusher of the handover station to be brought into a position in which it supports the first stop element in preventing the loading aid from toppling over or sliding over the first stop element during loading of the transport vehicle by pushing a loading aid onto the base of the loading platform.

In the proposed handover station, it is particularly advantageous for the guide to form a guide plane inclined by an angle of inclination in relation to a horizontal plane, the guide plane extending substantially parallel to the base of the loading platform. A loading aid can thereby be pushed onto the loading platform or pushed off the loading platform parallel to the (in relation to the horizontal plane, inclined) base. This way, the loading aid is prevented from getting stuck during pushing.

The pusher can comprise a pusher surface which is normally aligned with a guide plane and in such a way that during pushing off, the pusher with the pusher surface can engage substantially parallel to a side wall of the loading aid.

According to a possible embodiment, the angle of inclination of the guide can be adjustable, so that transport vehicles with differently inclined loading platforms can be served.

According to one embodiment, the pusher can be swivelable (and lockable in the swiveled out position) about an axis running parallel to the guide to enable the pusher to be folded away. The pusher can thus, for example, be brought into a suitable pushing-on position without collision in which the pusher can positively engage behind a loading aid positioned on the loading platform.

According to a favorable embodiment of the handover station, the conveying device comprises a carriage and a traction drive, wherein the carriage is coupled with the traction drive and is mounted to the guide using guide rollers, and wherein the pusher is mounted on the carriage. A translational movement of the carriage is thereby possible with simple technical means. The traction drive comprises a drive wheel, a deflection wheel and a traction mechanism routed around the drive wheel and the deflection wheel. The drive wheel is coupled to a drive motor. The traction means is preferably a toothed belt.

The handover station can additionally comprise stop elements, wherein one or more first stop elements are assigned to a first end position of a displacement path of the carriage, and one or more second stop elements are assigned to a second end position of a displacement path of the carriage. The stop elements can comprise damping elements, made from rubber, for example.

It is favorable for the handover station to additionally comprise a conveying system to transport the loading aid away from the receiving location and/or to transport the loading aid to the receiving location. This way, loading aids to be transferred from the transport vehicle can be transported away from the handover station and loading aids to be received by the transport vehicles transported into the handover station.

It is also advantageous for the handover station to additionally comprise a passageway which forms an entry zone, an exit zone and a driving path extending between the entry zone and exit zone, wherein the parking location is arranged along the driving path and the driverless transport vehicle can enter the handover station in the entry zone (stopping at the parking location) and exit the handover station in the exit zone. A movement direction of the driverless transport vehicle along the driving path and a movement direction of the pusher or the loading aid advantageously extend transversely (in particular at right angles) to one another.

The use of a transport vehicle in which the base is inclined to the side in relation to a longitudinal axis extending between the front vehicle side and rear vehicle side is particularly advantageous in this regard. A loading aid can thereby be transferred in the handover station without the driving direction of the transport vehicle having to be changed to move to a parking location and to leave the parking location.

It is also favorable for the handover station to additionally comprise a positioning system for positioning the driverless transport vehicle relative to the parking location. In particular, the positioning system can comprise positioning elements arranged (in particular stationary) on both sides of the driving path and symmetrically to a vertical plane extending in the direction of the driving path. For example, the positioning elements can each comprise a stop profile, wherein on their opposing side walls the stop profiles form a stop surface which can interact with a support frame of the driverless transport vehicle when the driverless transport vehicle is provided at the parking location and a loading aid is pushed from the loading platform of the driverless transport vehicle onto the receiving location and/or a loading aid is pushed from the receiving location onto the loading platform of the driverless transport vehicle.

The proposed measures can, on the one hand, facilitate or force a (lateral) positioning of the transport vehicle. For example, it would be conceivable for the positioning elements to, like guide rails, laterally guide the transport vehicle when entering the handover station and exiting the handover station. The transport vehicle can thereby be exactly centered between the positioning elements at the parking location. This is, indeed, not generally necessary with the stated driverless transport vehicles, although it can facilitate or force alignment in the event of positioning errors of the transport vehicle.

On the other hand, the proposed measures can prevent or at least limit a (lateral) tipping of the transport vehicle. The transport vehicle can tend to tip during loading and/or unloading, for example if heavy loading aids are moved on the loading platform and/or the transport vehicle has a narrow and tall configuration. In this case, the support frame of the transport vehicle would hit one or both positioning elements, whereby a further movement would be prevented.

It is favorable for the order-picking system to further comprise a third conveying system connecting the storage zone and the transfer zone, and comprising driverless transport vehicles for transporting articles (with or without loading aid) between the storage zone and the transfer zone. The transfer of articles from and into the storage zone can thus be performed in a particularly flexible manner.

It is thereby favorable for the first driving surface to additionally comprise a third driving surface section arranged between the storage zone and the transfer zone, and for the driverless transport vehicles of the third conveying system to move in the third driving surface section. The transport vehicles of the second and third conveying system thereby move on the first driving surface (in particular in the same plane). The third driving surface section can be connected with or be separate from the first and/or second driving surface section of the first driving surface.

It is additionally conceivable for the driverless transport vehicles of the third conveying system to not only move in the third driving surface section but also move to the storage places in the storage zone. The transport vehicles of the third conveying system can thereby exchange articles (with or without loading aid) between the storage zone and the transfer zone, in particular can retrieve articles (with or without loading aid) from the storage zone and transport them to the transfer zone and/or transport articles (with or without loading aid) from the transfer zone to the storage zone and store them in the storage zone. A special warehouse conveying system is then not required, or rather its function is assumed by the third conveying system.

Such a third conveying system comprising driverless transport vehicles movable in a horizontal direction (x and/or z direction) and a vertical direction (y direction) in the storage zone, and/or in a horizontal direction (x and/or z direction) in the region of a third driving surface section on the first driving surface, and/or in a vertical direction (y direction) in the transfer zone at a transfer station, is known from AT 525 735 B1 or EP 3 362 379 B1, for example.

It is also advantageous for the driverless transport vehicles to move exclusively in the storage zone and for the storage zone and the transfer zone to be arranged in such a way that
the articles (with or without loading aid) to be transferred directly from the storage zone to the first conveying system, or
the articles (with or without loading aid) to be transferred directly from the storage zone to the first conveying system and the articles (with or without loading aid) to be transferred directly from the first conveying system to the storage zone.

According to this embodiment, there is thus a direct transfer of the articles (with or without loading aid) between the first and third conveying systems. For example, the transport vehicles of the third conveying system can be configured so that they can transfer the articles (with or without loading aid) to the first conveying system and/or receive them from the latter, without the first conveying system having to be particularly configured to do so. For example, the transport vehicles of the third conveying system can comprise a transfer device for that purpose, which, for example, can have a conveying device, a pushing device, or a gripper for moving the article (with or without loading aid).

Such a third conveying system comprising driverless transport vehicles movable in a horizontal direction (x direction) in the storage zone, is known from EP 3 286 111 B1 or WO 2013/090970 A2, for instance.

It is favorable for the workstation in the transfer zone to have a transfer station, wherein the transfer station comprises
a first transfer location and a first transfer device assigned to the first transfer location, wherein the first transfer location is configured to receive an article (with or without loading aid) and wherein the first transfer device is configured to transfer the article (with or without loading aid) from the first transfer location to the first conveying system, and
a second transfer location and a transfer device assigned to the second transfer location, wherein the second transfer location is configured to receive an article (with or without loading aid) and wherein the second transfer device is configured to transfer the article (with or without loading aid) from the first conveying system to the second transfer location.

The proposed measures enable the coupling of first and third conveying systems, in particular of different types. For example, the first conveying system comprises stationary conveying devices, whereas the third conveying system comprises driverless transport vehicles. According to this embodiment variation, the transfer of an article (with or without loading aid) is performed by a first and second transfer device of the workstation, which, for example, can have a conveying device, a pushing device, or a gripper for moving the article (with or without loading aid). Accordingly, the transport vehicle need not have such a transfer device.

It is, however, also favorable for the workstation in the transfer zone to have a transfer station, wherein the transfer station comprises
a first transfer location configured to receive a transport vehicle of the third conveying system with the article (with or without loading aid), and a transfer device assigned to the transport vehicle, wherein the transfer device is configured to transfer the article (with or without loading aid) from the transport vehicle to the first conveying system, and
a second transfer location configured to receive a transport vehicle of the third conveying system, and a transfer device assigned to the transport vehicle, wherein the transfer device is configured to transfer the article (with or without loading aid) from the first conveying system to the transport vehicle.

This variation of the workstation is similar to the aforementioned variations. The article transfer is indeed performed by a transfer device of the transport vehicle, whereby the former can have, for example, a conveying device, a pushing device, or a gripper for moving the article (with or without loading aid), but the workstation comprises a first and second transfer location (and where applicable further facilities for receiving or positioning the transport vehicle). According to this embodiment variation, however, the transfer station need not have a transfer device.

In summary, a number of different variations are conceivable for the article transfer between the storage zone and the transfer zone of the workstation. For example, the transport vehicles of the third conveying system can transfer articles (with or without loading aid) from the storage zone to a warehouse conveying system and transport them from there to the transfer station, where they are transferred to the first conveying system. Thereafter, the first conveying system transports the articles (with or without loading aid) to the first provisioning device of the workstation. Return transport can be performed analogously. It would, however, also be conceivable for the transport vehicles of the third conveying system to directly collect articles (with or without loading aid) from a storage place in the storage zone or to transfer them to there. A special warehouse conveying system is then not required. Finally, it is also conceivable for the transfer of the articles (with or without loading aid) to be performed directly between the first and third conveying systems, eliminating the need for a transfer station.

It is also favorable for the transfer station of the workstation to comprise a lifting device assigned to the first conveying system, on which lifting device the transport vehicle or the article (with or without loading aid) can be received. The proposed measures can bridge height differences between the first and third conveying systems. In particular, the transfer station can also have a first lifting device for lifting a transport vehicle or an article (with or without loading aid) and a second lifting device for lowering a transport vehicle or an article (with or without loading aid). Thus, the article alone (with or without loading aid) or the entire transport vehicle including the article (with or without loading aid) can thus be moved vertically. For instance, lifts or paternosters known in the art can be an option as lifting devices.

It is favorable for the driverless transport vehicles of the second conveying system and the driverless transport vehicles of the third conveying system to have different structural configurations. The transport vehicles can thereby be optimized for their respective use purpose. For example, it can be advantageous for the driverless transport vehicles of the third conveying system to have an option for movement in a vertical direction (i.e. climbing), whereas this option can be superfluous for the driverless transport vehicles of the second conveying system. It would also be conceivable for the driverless transport vehicles of the third conveying system to be moved (at least at times) along guide rails, whereas the transport vehicles of the second conveying system move exclusively on (flat) first, second and third driving surfaces.

Alternatively, it would, however, also be conceivable for the driverless transport vehicles of the second conveying system and the driverless transport vehicles of the third conveying system to have identical structural configurations. Scaling effects result in a more economical structure and operation of the order-picking system.

In particular, the driverless transport vehicles of the second conveying system and the driverless transport vehicles of the third conveying system can have a similar structure and have at least some of the same technical features. For example, the driverless transport vehicles of the third conveying system can, in particular for transporting an article (with or without loading aid), each comprise
a support frame,
a chassis mounted on the support frame, the chassis comprising a plurality of wheels and being configured to drive or to drive and steer the driverless transport vehicle,
a controller configured to receive drive commands and to control the driverless transport vehicle, and
a loading platform mounted on the support frame, comprising a horizontally aligned base, in particular permanently fixed on the support frame or arranged on a lifting device.

What has been stated regarding the driverless transport vehicles of the second conveying system thereby applies analogously, such as that the driverless transport vehicles of the third conveying system can also be provided as AGVs or AMRs.

The object of the invention is also solved by the following measures in that
the first conveying system and the transport vehicles are controlled by the control unit in such a way that an article (with or without (source) loading aid) transported by the first conveying system, and a loading aid (target loading aid) transported by one of the transport vehicles, of an order arrive approximately simultaneously at the first and second provisioning positions,
wherein a loading aid is placed on the base of the loading platform, the base being inclined by an angle of inclination in relation to a horizontal plane,
wherein the loading aid comprises a base, side walls projecting from the base, and a loading opening delimited by the side walls, and
wherein the controller of the transport vehicle performs a drive command (which can be transmitted to the controller by the control unit) in such a way that the transport vehicle is provided at the second provisioning device in a pose in which the loading aid (target loading aid) in the second provisioning position (and via the base of the loading platform) is aligned or positioned in such a way to the first provisioning device (or the article (with or without (source) loading aid)) that an edge of a front side wall of the side walls lies lower than an edge of a rear side wall of the side walls in order to enable ergonomic loading of the loading aid with the article via the loading opening.

Particularly ergonomic loading of the (target) loading aid is achieved, wherein loading can be performed manually by a warehouse worker or automatically by a robot, as described above.

For a better understanding of the invention, it is explained in more detail with reference to the following figures.

They show in significantly simplified, schematic representation:

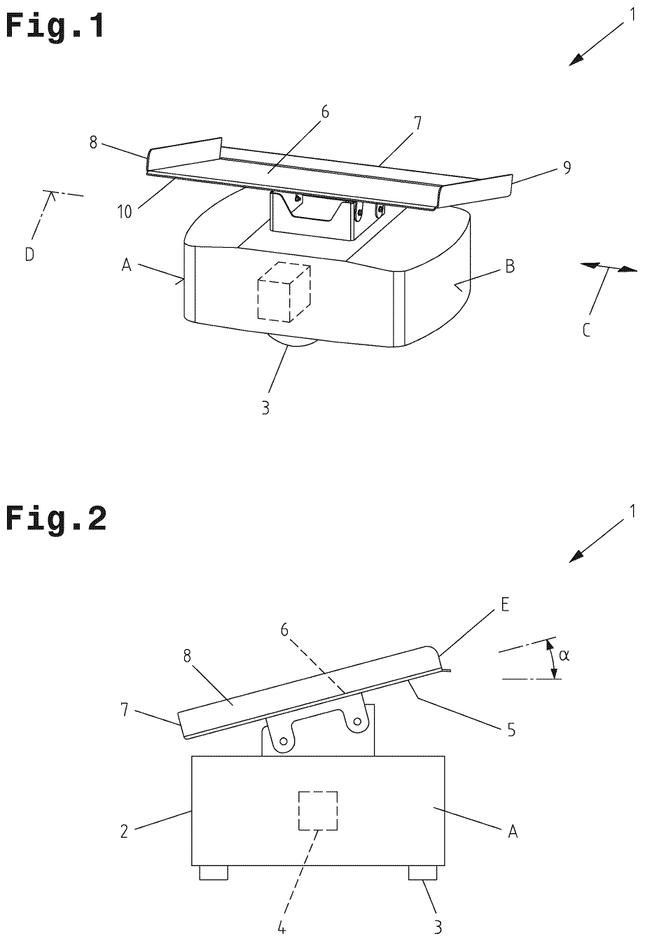

FIG. 1 an oblique view of a driverless transport vehicle with a laterally inclined loading platform;

FIG. 2 a side view of the transport vehicle from FIG. 1;

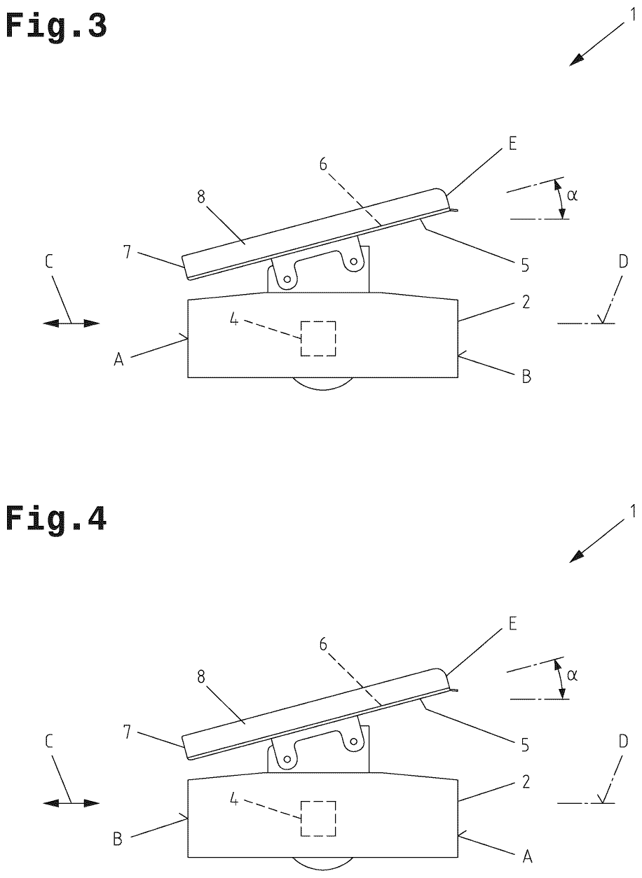

FIG. 3 a side view of a driverless transport vehicle with a loading platform inclined forwards;

FIG. 4 a side view of a driverless transport vehicle with a loading platform inclined rearwards;

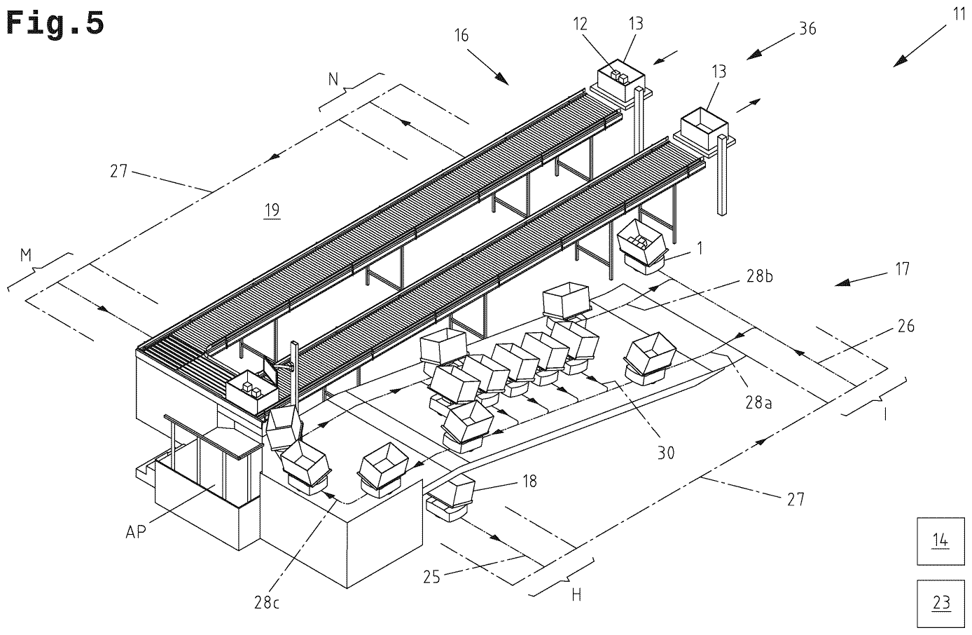

FIG. 5 an oblique perspective view of an example workstation with a first embodiment of a transfer station;

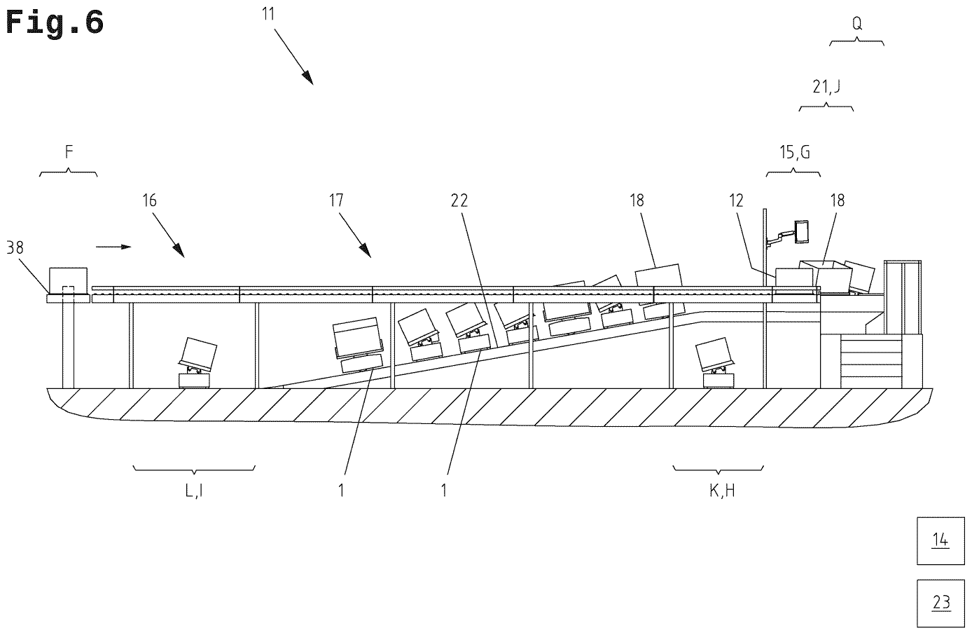

FIG. 6 a side view of the workstation from FIG. 5;

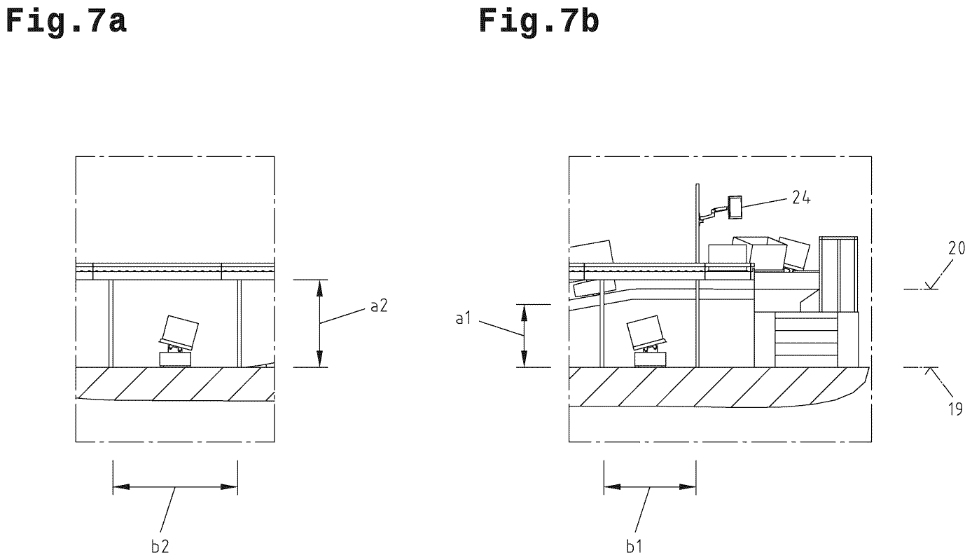

FIG. 7a a detailed view of FIG. 6 in the region of the additional passageway;

FIG. 7b a detailed view of FIG. 6 in the region of the passageway;

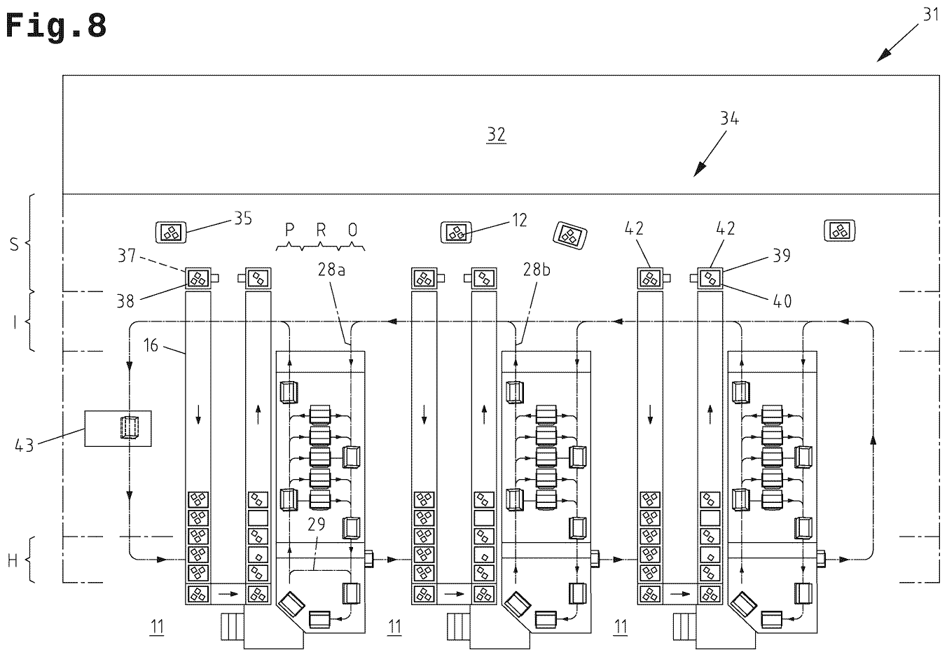

FIG. 8 a schematic top view of an example order-picking system with a plurality of workstations according to an embodiment of the workstation according to FIG. 6 and transport vehicles (of a third conveying system) between a storage zone and a corresponding transfer zone;

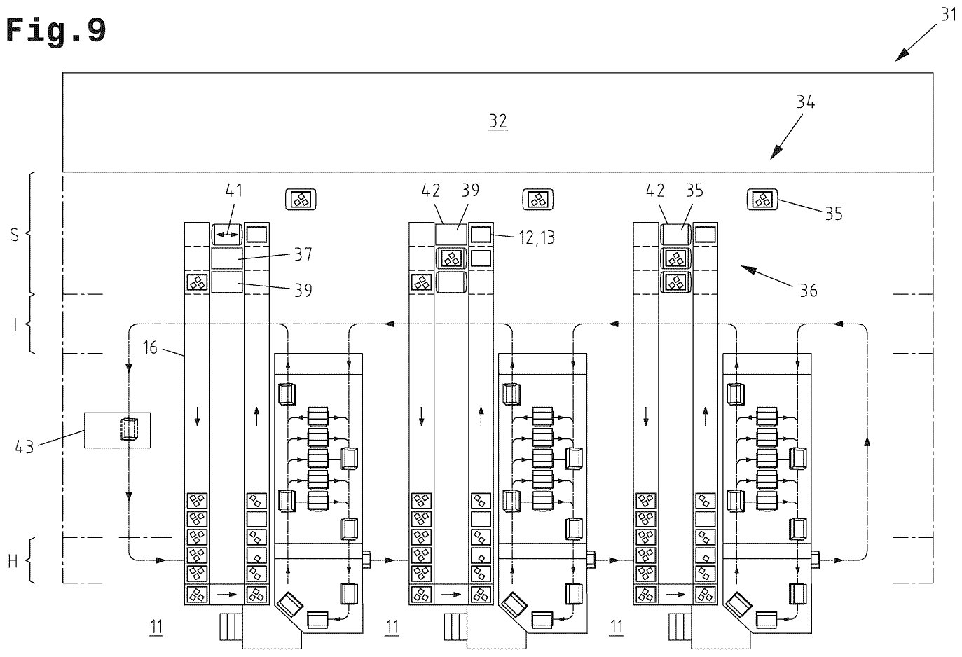

FIG. 9 a schematic top view of an example order-picking system similar to FIG. 8, however with a second embodiment of a transfer station and transport vehicles (of a third conveying system) between a storage zone and a corresponding transfer zone;

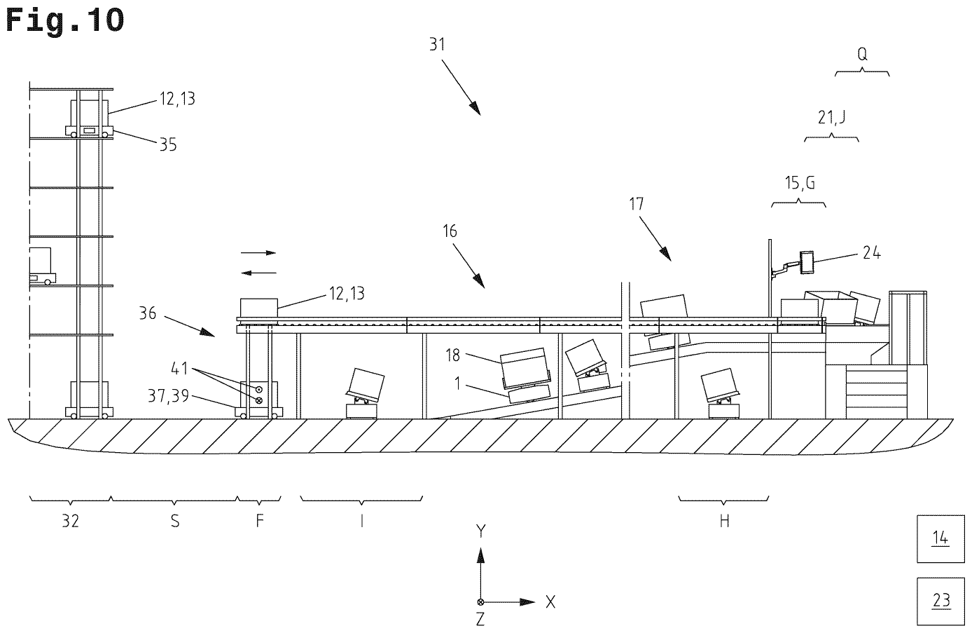

FIG. 10 a schematic side view of an example order-picking system with a third embodiment of a transfer station and transport vehicles (of a third conveying system), which can be moved in the storage zone as well as between a storage zone and a corresponding transfer zone;

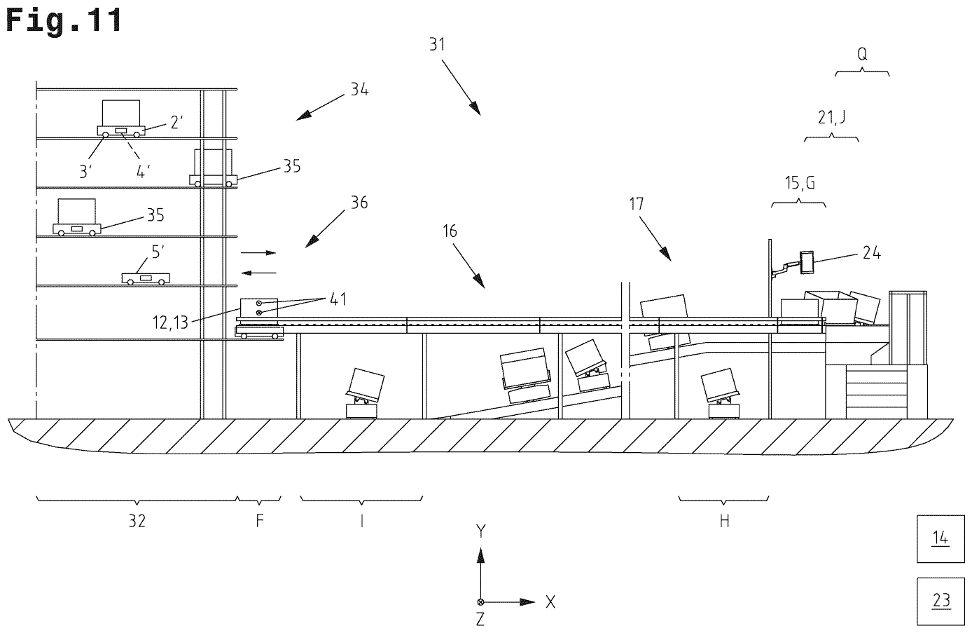

FIG. 11 a schematic side view of an example order-picking system with a fourth embodiment of a transfer station and a storage zone directly adjoining the transfer zone;

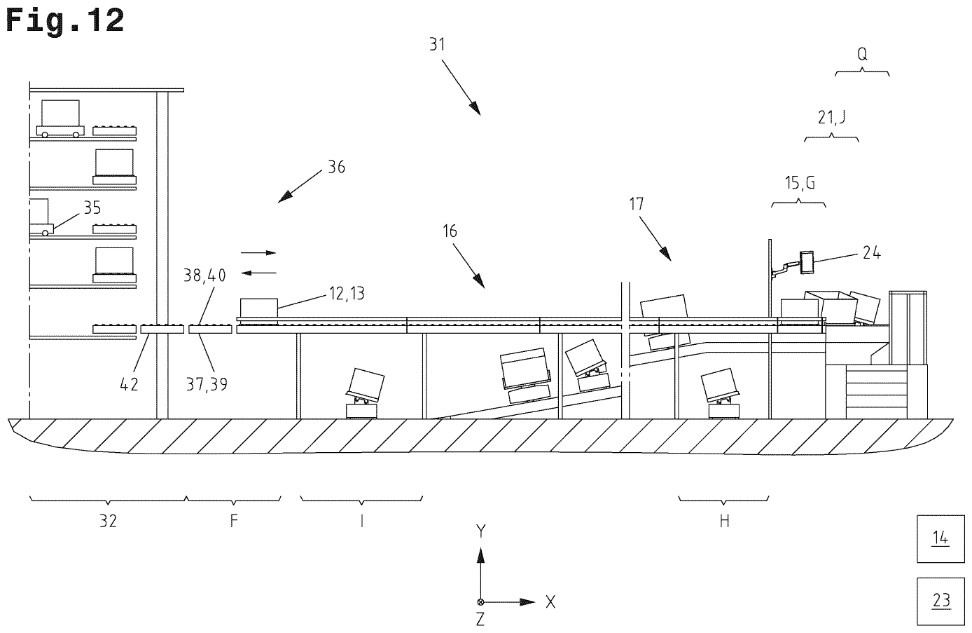

FIG. 12 a schematic side view of an example order-picking system with a fifth embodiment of a transfer station similar to FIG. 11, however with transport vehicles moving exclusively in the storage zone;

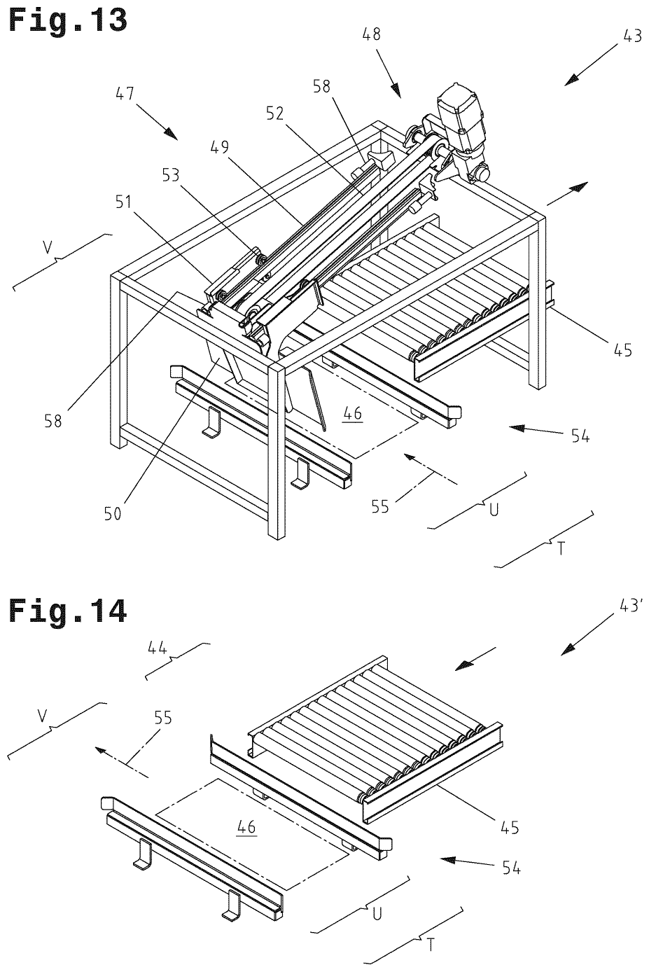

FIG. 13 an oblique view of a first embodiment of a handover station for loading and/or unloading a driverless transport vehicle (of a second conveying system);

FIG. 14 an oblique view of a second embodiment of a handover station for loading a driverless transport vehicle (of a second conveying system);

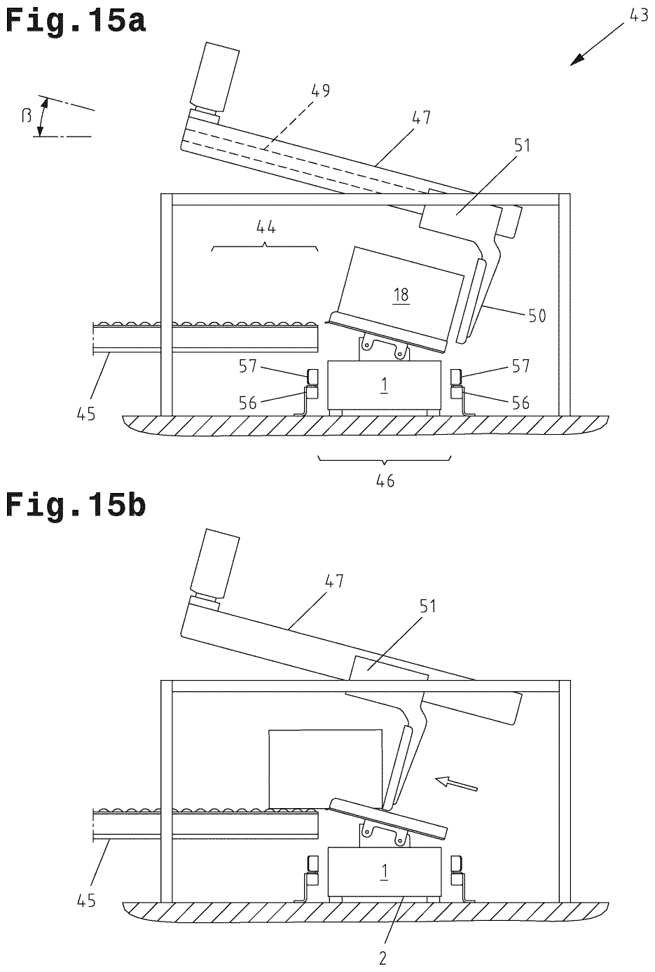

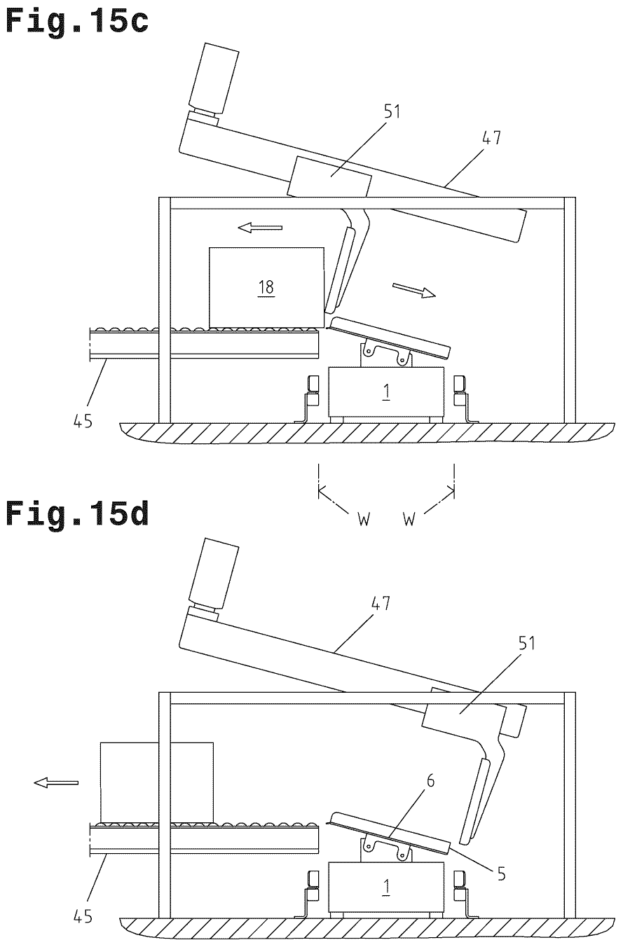

FIG. 15a . . . 15d a sequential progression of a handover (unloading) of a loading aid from a transport vehicle onto a receiving location at the handover station according to FIG. 13;

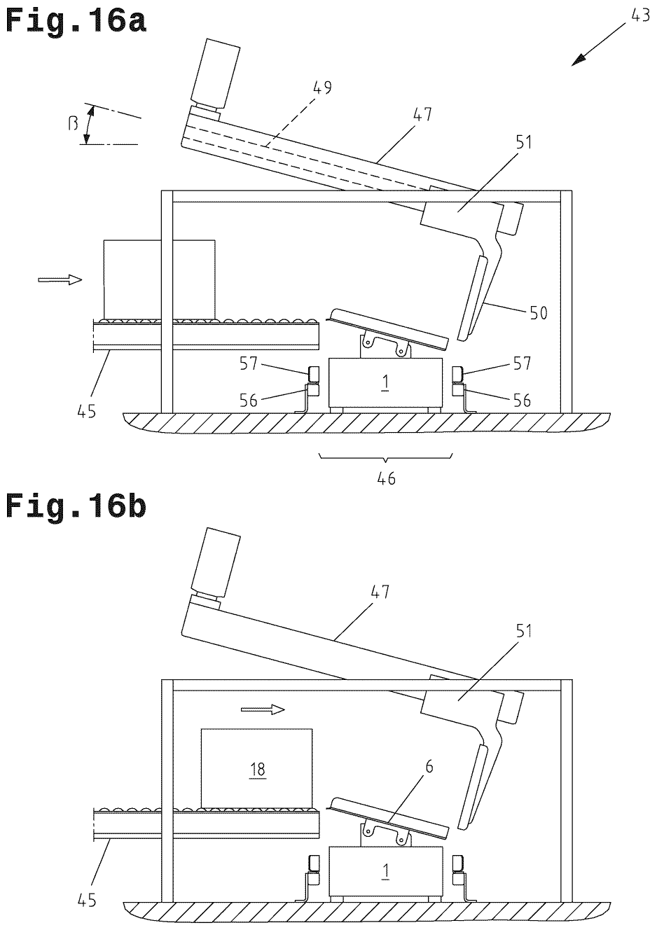

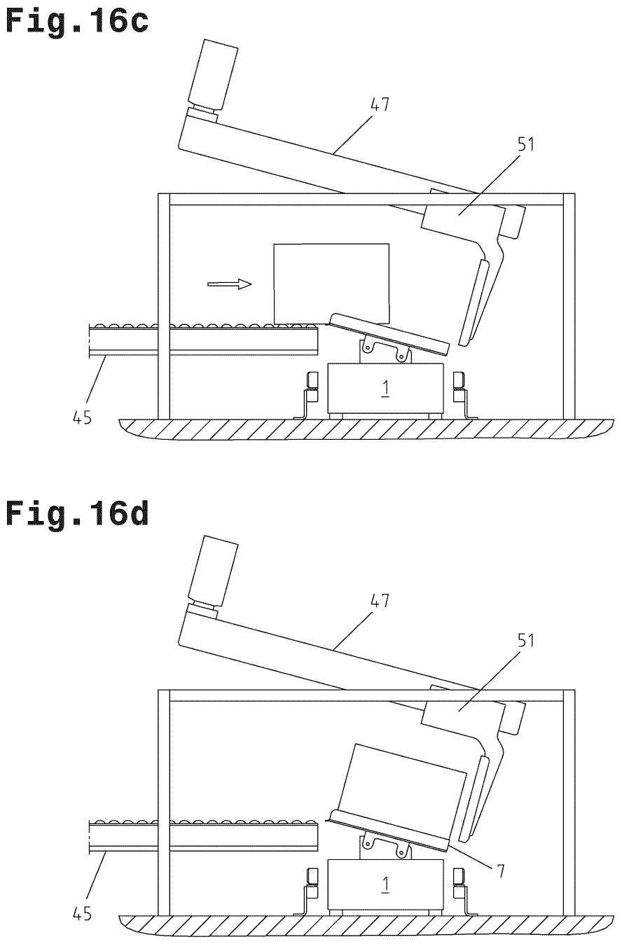

FIG. 16a . . . 16d a sequential progression of a handover (loading) of a loading aid from a receiving location onto a transport vehicle at the handover station according to FIG. 13.

It is worth noting here that the same parts have been given the same reference numerals or same component designations in the embodiments described differently, yet the disclosure contained throughout the entire description can be applied analogously to the same parts with the same reference numerals or the same component designations. The indications of position selected in the description, such as above, below, on the side etc. refer to the figure directly described and shown, and can be applied in the same way to the new position should the position change.

FIGS. 1 and 2 show a first embodiment of a driverless transport vehicle 1, which can be used to transport loading aids (not shown in FIGS. 1 and 2, see however FIG. 5 or FIG. 15a, for example). FIG. 1 shows an oblique view of the transport vehicle 1 from the rear left, and FIG. 2 shows a front view of the transport vehicle 1. The driverless transport vehicle 1 can also be used to transport an article.

The terms loading aid and article are used synonymously in the following.

The loading aid has a base, side walls projecting from the base, and a loading opening delimited by the side walls. The base is supported on the loading platform when the loading aid is positioned on the loading platform.

The loading aid is, for example, a box or a container.

The transport vehicle 1 comprises a support frame 2, a chassis 3 mounted on the support frame 2, a controller 4, and a loading platform 5 mounted on the support frame 2. The chassis 3 comprises a plurality of wheels and is configured to drive and steer the driverless transport vehicle 1. The controller 4 is configured to receive drive commands (e.g., from a superordinate controller) and to control the driverless transport vehicle 1. The transport vehicle 1 further has a front vehicle side A and a rear vehicle side B, as well as a (main) driving direction pointing in the direction of a longitudinal axis D of the transport vehicle 1 extending between the front vehicle side A and rear vehicle side B.

Only the wheels of the chassis 3 are visible in FIGS. 1 and 2. It can, however, comprise one or more drive motors, one or more drive shafts, bearings for the wheels, and where applicable one or more steering motors and the like. Preferably, steering of the driverless transport vehicle 1 is achieved through differential speed control of the wheels, wherein the wheels are drive wheels according to this embodiment. Each drive wheel is driven with a different speed in order to rotate. To drive forwards or backwards, the two drive motors are driven with the same speed. Alternatively, steering wheel control is also possible. In the case of steered wheel control, the drive wheel is preferably the wheel that steers. The transport vehicle 1 can, for example, be configured as an “Autonomous Mobile Robot (AMR)” or “Automated Guided Vehicle (AGV).

The loading platform 5 of the transport vehicle 1 comprises a base 6 permanently fixed, in particular screwed, on the support frame 2 and inclined by an angle of inclination α in relation to a horizontal plane. Loading of the transport vehicle 1 with a loading aid and/or unloading of a loading aid positioned on the loading platform 5 from the transport vehicle 1 is achieved with a technically simple transport vehicle 1 construction.

The loading platform 5 advantageously comprises a first stop element 7 arranged in a lower-lying side region of the base 6 and protruding in relation to the base 6, and a handover section E arranged in a higher-lying side region of the base 6, as shown in FIGS. 1 and 2. On the one hand, a loading aid placed on the loading platform 5 can thereby not unintentionally slide down from the loading platform 5, and on the other hand loading and/or unloading can be performed in a simple manner via the handover section E. A loading aid is thereby pushed up onto the loading platform 5 or pushed down from the same. Technically complex lifting and gripping devices are not required.

The loading platform 5 in the embodiment shown in FIGS. 1 and 2 further comprises an optional second stop element 8 arranged in a side region of the base 6 extending between the lower-lying side region of the base 6 and the higher-lying side region of the base 6 and protruding in relation to the base 6. The loading platform 5 also comprises an optional third stop element 9, which is similarly arranged in a side region of the base 6 extending between the lower-lying side region of the base 6 and the higher-lying side region of the base 6 and protruding in relation to the base 6. It is thereby possible to prevent a loading aid from unintentionally falling off the front or back of the loading platform 5 (that is to say, transverse to a slope line of the loading platform 5).

The loading platform 5 of the embodiment shown in FIGS. 1 and 2 also comprises an optional sliding support 10 arranged in the higher-lying side region of the base 6 and forming the handover section E. That way, loading of the transport vehicle 1 by pushing a loading aid up onto the loading platform 5 or unloading by pushing the loading aid down from the loading platform 5 can be performed in a particularly simple manner.

Furthermore, it is favorable for the base 6 of the loading platform 5 to provide a sliding plane. In particular, the sliding plane can stretch between the handover section E and the first stop element 7 and between the second stop element 8 and the third stop element 9. The proposed measures further simplify loading of the transport vehicle 1 by pushing an article or a loading aid up onto the loading platform 5 or unloading by pushing the article or loading aid down from the loading platform 5. For example, the sliding plane can have a slide coating for that purpose.

In the embodiment variation shown in FIGS. 1 and 2, the base 6 of the transport vehicle 1 comprises a base plate. In particular, smaller loading aids can thus be transported. It is also possible to transport a plurality of loading aids at the same time.

It is, however, also conceivable for the base 6 of the transport vehicle to comprise support profiles. A loading platform 5 with high stability and low weight can thereby be achieved.

Moreover, unintentionally leaking fluids can drain away through the loading platform 5, for example. The support profiles preferably extend parallel to one another with a mutual spacing between the handover section and the first stop element. The support profiles can, for example, be U-shaped or C-shaped.

In the embodiment shown, the base 6 specifically is laterally inclined by the angle of inclination α in relation to the longitudinal axis D. A loading aid can thereby be provided without the driving direction C of the transport vehicle 1 having to be changed to move to a provisioning position and to leave the same. In addition, a loading aid cannot unintentionally fall off the loading platform 5 so easily during acceleration or braking of the transport vehicle 1.

This is, however, not the only conceivable option for an inclination of the base 6. Rather, it is also conceivable that the base 6 can be inclined forwards or rearwards in the direction of the longitudinal axis D. In this respect, FIG. 3 shows a side view of an embodiment of a transport vehicle 1, which almost resembles the transport vehicle 1 shown in FIGS. 1 and 2. The only difference is that the transport vehicle 1 of FIG. 3 has a base 6 inclined forwards by the angle of inclination α in the direction of the longitudinal axis D. In addition, in this respect FIG. 4 shows a side view of a further embodiment of a transport vehicle 1, which also almost resembles the transport vehicles 1 shown in FIG. 1 to 3. The only difference is that the transport vehicle 1 of FIG. 4 has a base 6 inclined rearwards by the angle of inclination α in the direction of the longitudinal axis D. Advantageously, a loading aid cannot unintentionally fall off the loading platform 5 so easily when a transport vehicle 1 according to FIGS. 3 and 4 moves around a corner.

Generally, and thus in all embodiment variations shown, it is advantageous for the angle of inclination α of the base 6 to be in a range of 10° to 60°. In particular, the angle of inclination α can be in a range of 10° to 20°. An angle of inclination α of 12° is particularly advantageous. A loading aid located on the loading platform 5 can thereby be provided in a favorable position for loading and/or unloading. Moreover, a loading aid at such an angle of inclination α cannot unintentionally fall off the loading platform 5 so easily during movement of the transport vehicle 1 either.

FIGS. 5, 6, 7a and 7b now show an example workstation 11. FIG. 5 shows an oblique perspective view of the workstation 11, FIG. 6 shows a side view of the workstation 11 (seen from the left in relation to FIG. 5), and FIGS. 7a, 7b show details of the side view according to FIG. 6.

The workstation 11 comprises an order management system 14, a first provisioning device 15, a first conveying system 16 and a second conveying system 17.

The order management system 14 serves to electronically acquire orders, in particular picking orders. An order can comprise one order line or a plurality of order lines. An order line contains at least information about a (required) number of pieces of an article and about an article type. If the order specifies a plurality of order lines, it is possible that different articles are required.

The first provisioning device 15 serves to provide articles 12 at a first provisioning position G and the first conveying system 16, which in this example is constituted by stationary conveying devices, connects a transfer zone F and the first provisioning device 15 and is configured to transport the articles 12 between the transfer zone F and the first provisioning device 15. In particular, the articles 12 can be transported and provided with loading aids 13 of the first conveying system 16, as is shown in FIG. 5. The loading aids 13 equate to ‘source loading aids’, since they contain the article 12 for processing an order. The source loading aids 13 can, for example, be provided as containers, as is the case in FIG. 5, or be provided as a tray or box, for instance. The articles 12 can, however, also be transported and provided at the first conveying system 16 without loading aids 13. The articles 12 are accordingly transported directly on the first conveying system 16 and provided on the first provisioning device 15.

In the following, the terms article 12 and (source) loading aid 13 of the first conveying system 16 are used synonymously.

In the transfer zone F, articles 12 (from outside the workstation 11) are transferred onto the first conveying system 16 and/or from the first conveying system 16 (to outside the workstation 11). The role of the transfer zone F and the transfer station arranged in the transfer zone F, in particular of the lifting device, will be explained in more detail later.

The second conveying system 17 comprises driverless transport vehicles 1 for transporting the loading aids 18 of the second conveying system 17. The loading aids 18 equate to ‘target loading aids’, since they are loaded with the article 12 for processing an order.

The second conveying system 17 further comprises a first driving surface 19 having a first driving surface section H and a second driving surface section I, a second driving surface 20 comprising a second provisioning device 21 for providing target loading aids 18 with the driverless transport vehicles 1 at a second provisioning position J, and a third driving surface 22 arranged between the first driving surface 19 and the second driving surface 20. The first driving surface 19 is arranged in a ground plane, and the second driving surface 20 forms or comprises an elevated platform on which a transport vehicle 1 can temporarily stop at the second provisioning position J to provide a target loading aid 18. The third driving surface 22 connects the first driving surface 19 with the second driving surface 20 arranged at a different height level and accordingly has a ramp-like or ramp-shaped configuration.

The transport vehicles 1 of the second conveying system 17 are configured as shown in FIGS. 1 and 2. This provides advantages when providing the target loading aids 18, since the transport vehicle 1 need not change its driving direction C when moving to the second provisioning position J, when stopping at the second provisioning position J, and when leaving the second provisioning position J. The transport vehicles 1 of the second conveying system 17 can, however, also have a different construction. For example, they can be configured according to FIG. 3 or 4. Finally, it is also conceivable for the transport vehicles 1 to not have a permanently inclined loading platform 5 and to be configured according to the prior art, for instance.

The first conveying system 16 is arranged in a conveying section facing the first provisioning device 15 with a vertical spacing to the first driving surface 19. Likewise, the second driving surface 20 is arranged with a vertical spacing to the first driving surface 19. A passageway K is configured below the first conveying system 16 and the second driving surface 20, along which passageway the first driving surface section H extends and which has a clearance height al that enables a collision-free movement of the transport vehicles 1 each loaded with a target loading aid 18. A clearance width b1 of the passageway K is preferably dimensioned such that it corresponds at least to a width of a transport vehicle 1 or two transport vehicles 1 moving one next to the other (see FIG. 7b in this respect). Preferably, the clearance width bl corresponds to a width of a transport vehicle 1 loaded with a target loading aid 18. A clearance width b1 of the passageway K can also be dimensioned such that it corresponds to two transport vehicles 1 moving one next to the other. Preferably, the clearance width b1 corresponds to a width of two transport vehicles 1 each loaded with a target loading aid 18.

It can also optionally be provided that the first conveying system 16 is arranged in a conveying section facing away from the first provisioning device 15 at a vertical spacing to the first driving surface 19 and an additional passageway L is configured below the first conveying system 16, along which the second driving surface section I extends and which has a clearance height a2 that enables a collision-free movement of the transport vehicles 1 each loaded with a target loading aid 18. A clearance width b2 of the passageway L can, in turn, be dimensioned such that it corresponds at least to a width of a transport vehicle 1 or two transport vehicles 1 moving one next to the other. Preferably, the clearance width b2 corresponds to a width of a transport vehicle 1 loaded with a target loading aid 18. A clearance width b2 of the passageway L can also be dimensioned such that it corresponds to two transport vehicles 1 moving one next to the other. Preferably, the clearance width b2 corresponds to a width of two transport vehicles 1 each loaded with a target loading aid 18.

Finally, the workstation comprises a control unit 23 for controlling the first conveying system 16 and the transport vehicles 1 in such a way that an article 12 transported by the first conveying system 16, and a loading aid 18 transported by one of the transport vehicles 1, of an order arrive approximately simultaneously at the first and second provisioning positions G, J, whereupon the loading aid 18 can be loaded with the article 12.

In particular, the control unit 23 can be configured to control the following steps:
i) transport the article 12 to the first provisioning device 15 using the first conveying system 16,
ii) provide the article 12 at the first provisioning position G,
iii) transport a target loading aid 18 to the second provisioning device 21 with the transport vehicle 1, wherein the transport vehicle 1 is moved from the third driving surface 22 to the second driving surface 20 and on the second driving surface 20 to the second provisioning device 21,
iv) provide the target loading aid 18 at the second provisioning position J,
v) load the target loading aid 18 provided in step iv) with an article 12 provided in step ii) according to an order,
vi) following step v), transport the target loading aid 18 loaded with an article 12 away from the second provisioning position J with the transport vehicle 1, wherein the transport vehicle 1 is moved from the second provisioning device 21 on the second driving surface 20 to the third driving surface 22.

The first conveying system 16 can comprise a first conveying device for transporting articles 12 from the transfer zone F to the first provisioning device 15 and a second conveying device for transporting articles 12 from the first provisioning device 15 to the transfer zone F. The first conveying system 16 can also comprise a third conveying device comprising the first provisioning device 15 and connecting the first conveying device and the second conveying device. A one-way system for the articles can thus also be achieved in the first conveying system.

In this example, the first conveying system 16 comprises roller conveyors. It is, however, also conceivable for the first conveying system 16 to have belt conveyors or chain conveyors. A mixed construction is of course also possible, i.e. roller conveyors, belt conveyors and/or chain conveyors can be combined.

The first provisioning device 15 for providing articles 12 can have one first provisioning position G or a plurality of such provisioning positions G. Each provisioning position G is then assigned to an article 12 (or to various articles 12 or article types).

Likewise, the second provisioning device 21 can have a second provisioning position J or a plurality of such provisioning positions J for providing target loading aids 18 with transport vehicles 1. Each provisioning position J is then assigned to a target loading aid 18. In other words, the second provisioning device 21 can have a plurality of stopping positions for a plurality of transport vehicles 1.

The target loading aids 18 are configured as boxes in the example shown in FIGS. 5, 6, 7a and 7b. In particular, it is conceivable for the target loading aids 18 to be configured as (shipping) boxes. It is, however, also conceivable for the target loading aids 18 to be configured as containers or trays (and for the transport vehicles 1 to then potentially only have a slightly inclined or even horizontally aligned loading platform 5).

According to the embodiment shown in FIGS. 5, 6, 7a and 7b, the workstation 11 comprises a working location AP for manually loading the target loading aids 18 with the articles 12. It is thereby advantageous for the first provisioning device 15 and the second provisioning device 21 to be configured to provide an article 12 and a target loading aid 18 at an ergonomic provisioning height for manual loading. As can be seen in particular from the figures, an edge of the front side wall of the target loading aid 18 lies lower than an edge of the rear side wall of the target loading aid 18. This is achieved by the inclination of the base 6 of the loading platform 5 and of the pose of the driverless transport vehicle 1. For the manual processing of the orders, the workstation 1 comprises an input and/or output device 24, which is connected with the control unit 23.

An output device 24 is configured to receive loading instructions from the control unit 23 and to issue them to a warehouse worker (not shown). The warehouse worker is active in the working location AP. For example, the quantity of the articles 12 to be loaded onto a target loading aid 18 is issued. If a plurality of target loading aids 18 are provided at the same time at a plurality of second provisioning positions J, the target loading aid 18 which is to be (currently) loaded with articles 12 can also be issued. The output device 24 comprises, for example, a touchscreen, a loudspeaker and the like.

An input device 24 is configured to receive an input command and to transmit a control signal to the control unit 23. The input device 24 comprises, for example, a confirm button, a switch and the like. For instance, an input command is triggered by a confirm button. For example, the warehouse worker can confirm the completion of the loading process by pressing the confirm button. A combined input and/or output device 24 comprises features of the input device and the output device.

According to a further embodiment, the workstation 11 at the working location AP can alternatively or additionally comprise a loading robot for automatic loading of the target loading aids 18 with articles 12 (not shown). The loading robot can be connected with the control unit 23 to receive loading instructions from the former. The provision of an input and/or output device 24 is indeed not absolutely necessary when using a loading robot, although it is possible.

It is favorable for a first lane 25 to extend along the first driving surface section H and a second lane 26 to extend along the second driving surface section I, as is the case in the embodiment of the workstation 11 as shown. The first driving surface section H is configured so that the transport vehicles 1 are moved along the first lane 25. The first lane 25 can be configured as a one-way lane; the transport vehicles 1 are then thus only moved in one direction (see direction arrow in FIG. 5). Likewise, the second driving surface section I is configured so that the transport vehicles 1 are moved along the second lane 26. The second lane 26 can also be configured as a one-way lane; the transport vehicles 1 are then thus only moved in one direction (see direction arrow in FIG. 5). The movement directions of the transport vehicles 1 on the first driving surface section H and second driving surface section I are preferably opposed, as is the case in the embodiment of the workstation 11 as shown. The first lane 25 and second lane 26 preferably extend parallel to one another.

According to a possible embodiment, the first lane 25 can form a closed circulation in the first driving surface section H. Likewise, the second lane 26 can form a closed circulation in the second driving surface section I. It is thereby conceivable for the first lane 25 and the second lane 26 to be part of a shared circulation (as is the case in FIGS. 8 and 9) or for a plurality of first lanes 25 to form a circulation running (only) in the first driving surface section H and/or for a plurality of second lanes 26 to form a (different) circulation running (only) in the second driving surface section I (not shown in the figures).

A changeover lane 27 advantageously extends between the first lane 25 and the second lane 26, wherein the transport vehicles 1 can be moved on the first driving surface 19 between the first driving surface section H and the second driving surface section I. In other words, the transport vehicles 1 can be exchanged between the first driving surface section H and the second driving surface section I.

According to a possible embodiment, as denoted in FIG. 5, the changeover lane 27 can comprise a first changeover lane and a second changeover lane, such that the first changeover lane, the first lane 25, the second changeover lane and the second lane 26 form a closed circulation. The first changeover lane, the first lane 25, the second changeover lane and the second lane 26 can thereby be configured as one-way. The transport vehicles 1 are thus only moved in one direction (see direction arrows in FIG. 5).

It is advantageous for
an approaching lane 28a to diverge from the second lane 26 and a returning lane 28b to merge into the second lane 26,
the approaching lane 28a to extend in a first driving surface section O of the third driving surface 22,
the returning lane 28b to extend in a second driving surface section P of the third driving surface 22, and
a provisioning lane 28c to extend between the approaching lane 28a and the returning lane 28b in a driving surface section Q of the second driving surface 20, wherein the provisioning lane 28c is assigned to the second provisioning device 21, as is shown in the example embodiment of the workstation 11 in the figures.

A one-way system coupled to the second driving surface section I of the first driving surface can thereby be achieved on the second and third driving surfaces 20, 22. The transport vehicles 1 can thus move largely without impeding each other on the second and third driving surfaces 20, 22. The transport vehicles 1 are then moved in a single direction along the approaching lane 28a, provisioning lane 28c and returning lane 28b, wherein the approaching lane 28a and the returning lane 28b extend in particular parallel to one another.

It is particularly advantageous for one or more sorting lanes 30 to extend in a third driving surface section R of the third driving surface 22 between the approaching lane 28a and the returning lane 28b, as is the case in the example embodiment of the workstation 11 shown in the figures.

In other words, each sorting lane 30 diverges from the returning lane 28b and merges into the approaching lane 28a. A sorting device of the second conveying system 17 can be achieved on the third driving surface 22 with the proposed measures. Since at the same time the third driving surface 22 serves to bridge the height difference between the first driving surface 19 (in particular its second driving surface section I) and the second driving surface 20, a multiple use of the third driving surface 22 thus results, forming the basis for a particularly compact construction of the workstations 11 or making a particular contribution thereto. It should be noted here that sorting lanes 30 can be additionally arranged on the second driving surface 20, which also contributes to a compact construction of the workstations 11.

In the workstation 11 shown in FIGS. 5, 6, 7a and 7b, one or more optional and advantageous express lanes 29 can extend in the driving surface section Q of the second driving surface 20 between the approaching lane 28a and the returning lane 28b (see the workstations 11 in FIG. 8).

The express lane 29 is similar to a sorting lane 30, but is located particularly close to the second provisioning position J. Thus, the express lane 29 can be understood as a sorting lane 30 located close or closest to the second provisioning position J. Thus, alternatively to a sorting lane 30, a transport vehicle 1 can be moved along an express lane 29 if a target loading aid 18 has to be provided promptly at the second provisioning position J.

One transport vehicle 1 can be stopped (parked) in each of the sorting lanes 30 and the express lane 29. That means the sorting lanes 30 and the express lane 29 each have a sorting or waiting space. It is, however, also conceivable for the sorting lanes 30 and/or the express lane 29 to each have a plurality of sorting or waiting spaces and accordingly a plurality of transport vehicles 1 can be stopped (parked) in a sorting lane 30 or express lane 29.

It is now particularly advantageous for the control unit 23 to be additionally configured to control the first conveying system 16 and the transport vehicles 1 in such a way that the transport vehicles 1 sort the target loading aids 18 into an order determined depending on the order in which the articles 12 are provided at the first provisioning device 15, wherein a target loading aid 18 and an article 12 of an order in turn arrive approximately simultaneously at the first provisioning position G and the second provisioning position J. Efficient loading of the target loading aid 18 or efficient picking can thereby also be ensured if the transport vehicles 1 reach the third driving surface 22 at an inconvenient moment and/or in an inconvenient order. For example, the target loading aids 18 can be sorted into an order with the transport vehicles 1 by one of the transport vehicles 1 diverging from the returning lane 28b into a sorting lane 28c and another of the transport vehicles 1 moving past the transport vehicles 1 that have diverged into the sorting lane 28c. The transport vehicle 1 that diverged into the sorting lane 28c can then be moved from the sorting lane 28c into the approaching lane 28a.

If an order of the orders comprises a first order line and a second order line, wherein the first order line and second order line comprise articles 12 of different article types, it is also of particular advantage for the control unit 23 to be additionally configured such that
a target loading aid 18 for processing the first and second order lines is first transported by the transport vehicle 1 from the second provisioning device 21 via the returning lane 28b into a sorting lane 30 after loading of the target loading aid 18 with the article 12 of the first order line and is buffered in the sorting lane 30, and thereafter the target loading aid 18 is transported from the sorting lane 30 via the approaching lane 28a to the second provisioning device 21 when the article 12 of the second order line is transported to the first provisioning device 15 by the first conveying device 16.

Particularly efficient loading of the target loading aid 18 or particularly efficient picking can thereby be achieved, even if the articles 12 cannot be provided at the first provisioning device 15 (provisioning position G) at the same time. This is thus also the case, for example, if the articles 12 are transported sorted by type in different source loading aids 13, yet articles 12 of different article types are to be loaded into a target loading aid 18 and only one first provisioning position G or too few provisioning positions G is/are available for a simultaneous provision of the required article types.

Furthermore, it is also advantageous for
a plurality of orders to comprise articles 12 of the same article type,
a target loading aid 18 to be assigned to each order, and
the control unit 23 to be additionally configured to control the loading of each of the target loading aids 18 assigned to the orders with an article 12 of the same article type,
wherein the article 12 is provided once at the first provisioning device 15 and the target loading aids 18 are provided at the second provisioning device 21 on one transport vehicle 1 each.

Particularly efficient loading of target loading aids 18 or particularly efficient picking can thereby also be achieved, even if it is not possible to provide a plurality of target loading aids 18 (or not all required target loading aids 18 which are to be loaded with articles 12 of the same article type) at the second provisioning device (provisioning position J) at the same time. This can, for example, be the case if only one second provisioning position J or too few second provisioning positions J is/are available.

The target loading aids 18 can be provided at the second provisioning device J one after the other on one transport vehicle 1 each if a single second provisioning position J is provided. The target loading aids 18 can, however, also be provided next to one another on one transport vehicle 1 each at the second provisioning device 21 if a plurality of second (in particular sufficient second) provisioning positions J are provided.

As described above, the first conveying system 16 can comprise a first conveying device, a second conveying device and a third conveying device.

Furthermore, it is favorable for the first conveying system 16 to comprise a plurality of buffer locations and the control unit 23 to be additionally configured to provide an article 12 of a different article type one after the other, wherein the article 12 is buffered at the buffer locations. The buffer locations are similar in their function to the sorting lanes 30 (or sorting locations on the sorting lanes 30) and can be arranged between the first conveying device, leading from the transfer zone F to the first provisioning device 15, and the second conveying device leading from the first provisioning device 15 to the transfer zone F. The buffer locations can, however, be assigned only to the first conveying device (if the articles 12 are to be buffered during transport to the first provisioning device 15) or only to the second conveying device (if the articles 12 are to be buffered during transport away from the first provisioning device 15). The buffer locations can also be used to provide articles 12 sorted in a predeterminable order.

In this regard, it is also advantageous for the first conveying system 16 to comprise a sorting buffer configured to provide articles 12 sorted in an order. The sorting buffer comprises a plurality of buffer locations arranged along the first conveying device, and/or a plurality of sorting spaces arranged along the second conveying device, and a plurality of sorting conveying devices connecting the sorting spaces and buffer locations.

It should be noted here that buffer locations, sorting spaces and sorting conveying devices of the first conveying system 16 are not shown here, but regarding the article flow they can be configured in the same or a similar way to the second conveying system 17.

Finally, it is advantageous for the first lane 25 extending in the first driving surface section H and the second lane 26 extending in the second driving surface section I to each have a coupling zone M, N and be connectable with coupling zones M, N of a further workstation 11 adjacent to the workstation 11. In particular, the workstations 11 can have an identical construction. Accordingly, a group can be formed out of a plurality of workstations 11 comprising a plurality of workstations 11 of one of the types described above arranged one next to the other, wherein the first driving surface sections H and second driving surface sections I of the workstations 11 are connected with one another (also see FIGS. 8 and 9). The group of workstations 11 can be scaled almost at will.

FIG. 8 now shows a schematic view from above of a first embodiment of an example order-picking system 31 for picking orders 12. The order-picking system 31 comprises a storage zone 32 in which storage places for providing articles 12 are arranged, and a picking zone for processing orders in which a plurality of (here three) workstations 11 of the aforementioned type are arranged. The three workstations 11 are connected with one another in their coupling zones M, N and form a group of workstations. In addition, the first lane 25 and the second lane 26 are part of a closed circulation for the transport vehicles 1, which extends across the entire group of the workstations 11. It would also be conceivable for a plurality of first lanes 25 and a plurality of second lanes 26 to be part of a plurality of separate closed circulations or lanes. In particular, the plurality of first lanes 25 and plurality of second lanes 26 can extend parallel to one another. It is also conceivable for the first lane 25 and the second lane 26 to be connected between two workstations 11, such that alternatively or in addition a smaller circulation is formed. Such connections can also be provided at other points between two workstations 11. It is also conceivable for connections of the first and second lanes 25, 26 to be provided between all workstations 11, whereby a plurality of different sized circulations arises which can be used selectively by the transport vehicles 1. It should be noted here that the size of the group of workstations 11 is selected purely by way of example and the group of workstations 11 can also be (significantly) larger. The order-picking system 31 can, however, also comprise just one workstation 11.

According to this embodiment variation, the order-picking system 31 also comprises an optional third conveying system 34 connecting the storage zone 32 and the transfer zone F, and comprising driverless transport vehicles 35 for transporting articles 12 (in particular with loading aids of the third conveying system 34) between the storage zone 32 and the transfer zone F.

The driverless transport vehicles 1 of the second conveying system 17 and the driverless transport vehicles 35 of the third conveying system 34 can be of identical structural configuration.

The driverless transport vehicles 1 of the second conveying system 17 and the driverless transport vehicles 35 of the third conveying system 34 can, however, also be of different structural configuration. The transport vehicles 1, 34 can thereby be optimized for their respective use purpose. For example, it can be advantageous for the driverless transport vehicles 35 of the third conveying system 34 to have an option for movement in a vertical direction (i.e. climbing) (see in this respect FIGS. 10 and 11), whereas this option can be superfluous for the driverless transport vehicles 1 of the second conveying system 17. It would also be conceivable for the driverless transport vehicles 35 of the third conveying system 34 to move (at least at times) along rails, whereas the transport vehicles 1 of the second conveying system 17 move exclusively on (flat) first, second and third driving surfaces.

In particular, the driverless transport vehicles 1 of the second conveying system 17 and the driverless transport vehicles 35 of the third conveying system 34 can have a similar structure and have at least some of the same technical features. For example, the driverless transport vehicles 35 of the third conveying system 34 can, in accordance with the transport vehicle 1 shown in FIGS. 1 and 2, each comprise
a support frame,
a chassis mounted on the support frame, the chassis comprising a plurality of wheels and being configured to drive and optionally to steer the driverless transport vehicle 35,
a controller configured to receive drive commands and to control the driverless transport vehicle 35, and
a loading platform mounted on the support frame, comprising (in deviation from the transport vehicle 1 shown in FIGS. 1 and 2) a horizontally aligned base, in particular permanently fixed on the support frame or arranged on a lifting device.

The order-picking system 31 shown in FIG. 8 comprises the first driving surface 19 and additionally an optional third driving surface section S arranged between the storage zone 32 and the transfer zone F, wherein the driverless transport vehicles 35 of the third conveying system 34 move in the third driving surface section S. Furthermore, it is conceivable for the transport vehicles 35 to move to the storage places in the storage zone 32 to receive or transfer articles 12 there.

In the embodiment variation of the order-picking system 31 shown in FIG. 8, each workstation 11 in the transfer zone F has a transfer station 36 comprising a first transfer location 37 and a transfer device 38 assigned to the first transfer location 37 as well as a second transfer location 39 and a transfer device 40 assigned to the second transfer location 39.

The first transfer location 37 is configured to receive an article 12 (in particular with source loading aid 13), and the first transfer device 38 is configured to transfer the article 12 (in particular with source loading aid 13) from the first transfer location 37 to the first conveying system 16. In other words, an article 12 (with or without source loading aid 13) can be transferred from a transport vehicle 35 to the first transfer location 37 and be transferred via the first transfer device 38 from the first transfer location 37 to the first conveying system 16. The handover of the article 12 from the transport vehicle 35 to the first transfer location 37 can be performed by a transfer device not shown here, for example a conveying device comprising the transport vehicle 35. The first transfer device 38 can comprise a conveying device.

The second transfer location 39 is configured to receive an article 12 (in particular with source loading aid 13), and the second transfer device 40 is configured to transfer the article 12 (in particular with source loading aid 13) from the first conveying system 16 to the second transfer location 39. In other words, an article 12 (with or without source loading aid 13) can be handed over to the second transfer location 39 and be transferred via the second transfer device 40 from the second transfer location 39 to a transport vehicle 35. The handover of the article 12 from the first conveying system 16 to the second transfer location 39 can be performed by a transfer device not shown here, for example a conveying device comprising the first conveying system 16. The second transfer device 40 can comprise a conveying device. For the aforementioned purpose, the transfer station 36 can comprise an optional lifting device 42 assigned to the first conveying system 16, as is the case in FIG. 8 and as shown schematically in FIG. 5. In specific terms, the lifting device 42 comprises a first lifting unit with a first transfer location 37 for lifting an article 12 and a second lifting unit with a second transfer location 39 for lowering an article 12. The first transfer location 37 can be arranged in particular on a lifting platform of the first lifting unit, and the second transfer location 39 can be arranged in particular on a lifting platform of the second lifting unit. Fundamentally, however, a different construction of the lifting device 42 is imaginable. For instance, it can have a different number of lifting units and/or not be configured as a lift but rather as a paternoster, for example.

Finally, the order-picking system 31 shown in FIG. 8 comprises an optional handover station 43 for automatically transferring a target loading aid 18 between the loading platform 5 of a driverless transport vehicle 1 and a receiving location 44. The handover station 43 is arranged on the first driving surface 19 between the first lane 25 and the second lane 26, for example along the changeover lane 27; it could, however, be arranged elsewhere. The function of the handover station 43 is explained in detail later.

FIG. 9 now shows a schematic top view of a second embodiment of an example order-picking system 31 which has a very similar construction to the order-picking system 31 of FIG. 8, albeit with differences with respect to the transfer zone For transfer station 36.

The transfer station 36 of each workstation 11 in FIG. 9 comprises a first transfer location 37 configured to receive a transport vehicle 35 of the third conveying system 34 with the article 12, and a transfer device 41 assigned to the transport vehicle 35 configured to transfer the article 12 from the transport vehicle 35 to the first conveying system 16. In other words, a transport vehicle 35 can be positioned at the first transfer location 37 and the article 12 is transferred by the transfer device 41 to the first conveying system 16.

The transfer station 36 further comprises a second transfer location 39 configured to receive a transport vehicle 35 of the third conveying system 34 (without the article 12), and a transfer device 41 assigned to the transport vehicle 35 configured to transfer the article 12 from the first conveying system 16 to the transport vehicle 35. In other words, a transport vehicle 35 is positioned at the second transfer location 39 and the article 12 is transferred from the first conveying system 16 by the transfer device 41.

As can be seen in the figure, the lifting device 42 is arranged between the first conveying device for transporting articles 12 from the transfer zone F to the first provisioning device 15 and the second conveying device for transporting articles 12 from the first provisioning device 15 to the transfer zone F. That is particularly space-saving.

For the aforementioned purpose, the transfer station 36 can comprise an optional lifting device 42 assigned to the first conveying system 16, as is the case in the example shown in FIG. 9. In specific terms, the lifting device 42 comprises three lifting units in this case. The first lifting unit comprises a first transfer location 37, the second lifting unit comprises a second transfer location 39, and the third lifting unit comprises a first or second transfer location 37, 39. The first transfer location 37 is arranged in particular on a lifting platform of the lifting units, and the second transfer location 39 is arranged in particular on a lifting platform of the lifting units. Naturally, the lifting device can also comprise more than three lifting units. Fundamentally, a different construction of the lifting device 42 is also imaginable. For instance, it can have a different number of lifting units and/or not be configured as a lift but rather as a paternoster, for example. If a lifting device 42 is provided, a transfer of an article 12 (with or without source loading aid 13) between the first conveying system 16 and the transport vehicle 1 can then take place once the transport vehicle 1 has been moved to the height level of the first conveying system 1.

It proves advantageous for the transport vehicles 35 to each have the transfer device 41.

FIG. 10 shows a side view of a third embodiment of an example order-picking system 31 in which the transport vehicles 34 of the third conveying system 35 can directly collect or transfer articles 12 (with or without source loading aid 13) from or to a storage place in the storage zone 32. The transport vehicles 34 can thus move within the storage zone 32, in the third driving surface section S and in the transfer zone F. According to this embodiment, the transport vehicles 34 can independently surmount vertical distances in the storage zone 32 by climbing up and down a support structure of the storage zone 32. Likewise, they can move horizontally on the individual storage planes of the storage zone 32 and thereby reach the storage places (see left area in FIG. 10). The transport vehicles 34 reach the transfer zone F via the third driving surface section S, where they can climb up and down a support structure of the transfer station 36. If a transport vehicle 34 is in the upper height position on the support structure, the article 12 can be transferred by the transfer device 41 to the first conveying system 16 or be received from the first conveying system 16.

Alternatively to the support structure of the transfer station 36, a lifting device 42 not shown here can be provided comprising a lifting unit with a lifting platform for lifting and lowering a transport vehicle 34. If the lifting platform with the transport vehicle 34 is in the upper height position, the article 12 can be transferred by the transfer device 41 to the first conveying system 16 or be received from the first conveying system 16.

It proves advantageous for the transport vehicles 35 to each have the transfer device 41.

FIG. 11 shows a side view of a fourth embodiment of an example order-picking system 31, which is very similar to the order-picking system 31 shown in FIG. 10. In contrast thereto, in this embodiment the storage zone 32 directly adjoins the transfer zone F, hence why the third driving surface section S is superfluous here. Likewise, a lifting device 42 is superfluous since the transport vehicles 35 can directly reach the height level of the first conveying system 16 via the storage zone 32. The transport vehicles 35 can transfer an article 12 using the transfer device 41 to the first conveying system 16 or receive one from the first conveying system 16 in the manner previously described.

It proves advantageous for the transport vehicles 35 to each have the transfer device 41.

In the embodiment variation according to FIG. 11, the driverless transport vehicles 35 move predominantly in the storage zone 32 and into the transfer zone F, and the storage zone 32 and the transfer zone F are arranged in such a way that
the articles 12 (with or without source loading aid 13) are transferred directly from the storage zone 32 to the first conveying system 16, or
the articles 12 (with or without source loading aid 13) are transferred directly from the storage zone 32 to the first conveying system 16 and the articles 12 (with or without source loading aid 13) are transferred directly from the first conveying system 16 to the storage zone 32.

It should be noted here that the support frame, the chassis, the controller and the loading platform of the transport vehicle 35, in deviation from the designation used in FIG. 1, are designated in FIG. 11 with the reference numerals 2′ . . . 5′ to make the difference clear that the transport vehicles 35 can have a different construction to the transport vehicle 1 of FIG. 1.

FIG. 12 shows a side view of a fifth embodiment of an example order-picking system 31, which is very similar to the order-picking system 31 shown in FIG. 11. However, according to this embodiment variation the driverless transport vehicles 35 move exclusively in the storage zone 32, wherein the transport vehicles can transfer the articles 12 to transfer locations in the storage zone 32 or receive them from there. The articles 12 can be transported from these transfer locations by the lifting device 42 to the height level of the first conveying system 16 and be transferred to the transfer locations 37, 39 or be received from them. From there, the articles 12 are transferred to the first conveying system 16 or received from it using the transfer devices 38, 39. Fundamentally, it would also be possible for the transfer devices 38, 39 to directly receive the articles 12 from the lifting device 42 or to transfer them to it, thus making a direct transfer from and to the first conveying system 16 possible. The transfer locations 37, 39 are then superfluous.

The storage zone 32 shown in FIG. 12 is described in more detail in EP 3 286 111 B1 and WO 2013/090970 A2, for example.

FIG. 13 now shows an oblique view of an example embodiment of a handover station 43 for automatically transferring a loading aid 18 between the loading platform 5 of a driverless transport vehicle 1 and a receiving location 44 (also see the side view of the handover station 43 shown in FIG. 15a). The handover station 43 comprises a driverless transport vehicle 1 of the type described above (also see FIG. 1 to 4), a parking location 46 for the driverless transport vehicle 1 and a transfer device 47 with a pusher 50 movable relative to the receiving location 44 and along a guide 49 by a drive device 48. The transport vehicle 1 is positionable in such a way at the parking location 46 that the loading platform 5 of the driverless transport vehicle 1 is aligned with the receiving location 44. If that condition is fulfilled, the pusher 50 can push the loading aid 18 from the loading platform 5 of the driverless transport vehicle 1 onto the receiving location 44 or from the receiving location 44 onto the loading platform 5 of the transport vehicle 1, or at least support this process (also see FIG. 15a . . . 16d). It is thereby advantageous for the guide 49 to form a guide plane inclined by an angle of inclination β in relation to a horizontal plane, the guide plane extending substantially parallel to the base 6 of the loading platform 5, as is the case in the example shown in FIG. 13 (also see FIG. 15a for the angle of inclination β).

In the embodiment variation shown in FIG. 13, the drive device 48 comprises a carriage 51 and a traction drive 52, wherein the carriage 51 is coupled with the traction drive 52 and is mounted to the guide 49 using guide rollers 53, and wherein the pusher 50 is mounted on the carriage 51. A translational movement of the carriage 51 is thereby possible with simple technical means. The traction drive 52 comprises a drive wheel, a deflection wheel and a traction mechanism routed around the drive wheel and the deflection wheel. The drive wheel is coupled to a drive motor. The traction means is preferably a toothed belt.

As shown in FIG. 13, the transfer device 47 can additionally comprise stop elements 58, wherein preferably a two-part stop element 58 is assigned to a first end position of a displacement path of the carriage 51, and preferably a further two-part stop element 58 is assigned to a second end position of a displacement path of the carriage 51. The stop elements 58 can comprise damping elements, made from rubber, for example.

Furthermore, it is favorable for the handover station 43 to additionally comprise a conveying system 45 to transport the loading aid 18 away from the receiving location 44 and/or to transport the loading aid 18 to the receiving location 44, as is the case in the embodiment shown. This way, loading aids 18 received from the transport vehicle 1 can be transported away from the handover station 43 and/or loading aids 18 to be received from the transport vehicles 1 transported into the handover station 43 in a simple manner.

The embodiment of the handover station 43 shown in FIG. 13 additionally comprises an optional passageway T, which forms an entry zone U, an exit zone V and a driving path 55 extending between the entry zone U and the exit zone V. The parking location 46 is thereby arranged along the driving path 55. The driverless transport vehicle 1 can thus enter the handover station 43 in the entry zone U, stop at the parking location 46, and exit the handover station 43 in the exit zone V. A driving direction of the driverless transport vehicle 1 along the driving path 55 and a movement direction of the pusher 50 or the loading aid 18 advantageously extend transversely (in particular at right angles) to one another.

In this regard, the use of a transport vehicle 1 in which the base 6 is inclined to the side in relation to a longitudinal axis D extending between the front vehicle side A and rear vehicle side B is particularly advantageous, as is the case in the embodiment of the transport vehicle 1 shown in FIGS. 1 and 2 (also see FIG. 15 a . . . 16 d). A loading aid 18 can thereby be provided without the driving direction of the transport vehicle 1 having to be changed to move to a provisioning position at the parking location 46 and to leave the same.

The shown embodiment of the handover station 43 additionally comprises an optional positioning system 54 for positioning the driverless transport vehicle 1 in relation to the parking location 46. In specific terms, the positioning system 54 comprises positioning elements 56 arranged (in this case stationary) on both sides of the driving path 55 and symmetrically to a vertical plane extending in the direction of the driving path 55. The positioning elements 56 each comprise a stop profile 57. On their opposing side walls the stop profiles 57 form a stop surface W which can interact with a support frame 2 of the driverless transport vehicle 1 (in particular) when the driverless transport vehicle 1 is provided at the parking location 46 and a loading aid 18 is pushed from the loading platform 5 of the driverless transport vehicle 1 onto the receiving location 44 and/or a loading aid 18 is pushed from the receiving location 44 onto the loading platform 5 of the driverless transport vehicle 1.

The proposed measures can, on the one hand, facilitate or force a (lateral) positioning of the transport vehicle 1. For example, it would be conceivable for the positioning elements 56 to, like guide rails, laterally guide the transport vehicle 1 during entry and exit. The transport vehicle 1 can thereby be exactly centered between the positioning elements 56 at the parking location 46. This is, indeed, not generally necessary with the computer-controlled driverless transport vehicles 1, although it can facilitate or force alignment in the event of positioning errors of the transport vehicle 1.

On the other hand, the proposed measures can prevent or at least limit a (lateral) tipping of the transport vehicle 1. The transport vehicle 1 can tend to tip during loading and/or unloading, for example if heavy loading aids 18 are moved on the loading platform 5 and/or the transport vehicle 1 has a narrow and tall configuration. In this case, the support frame 2 of the transport vehicle 1 would hit one or both positioning elements 56, whereby a further movement would be prevented.

FIG. 14 shows a further example embodiment of a handover station 43′ for automatically transferring a loading aid 18 between the loading platform 5 of a driverless transport vehicle 1 and a receiving location 44.

The handover station 43′ also comprises a parking location 46 for the driverless transport vehicle 1 and a conveying system 45 for transporting the loading aid 18 (not shown) to the receiving location 44. In specific terms, the handover station 43′ also comprises a positioning system 54 of the type already described in connection with FIG. 13. The loading of the driverless transport vehicle 1, in particular of the driverless transport vehicle 1 according to FIG. 1 to 4, with a loading aid 18 is performed via the conveying system 45 in this embodiment.

Additionally, 15a to 15d now show the handover (unloading operation) of a loading aid 18 (loaded with an article 12) from the transport vehicle 1 onto the receiving location 44. For the transfer of the loading aid 18, the transport vehicle 1 is positioned at the parking location 46 in such a way that its loading platform 5 is aligned with the receiving location 44.

In FIG. 15a, the pusher 50 is in its starting position and is not yet touching the loading aid 18. FIG. 15b shows a state in which the pusher 50 has already pushed the loading aid 18 so far to the left that it has tipped from the loading platform 5 onto the receiving location 44. In FIG. 15c, the loading aid 18 is already entirely on the receiving location 44, and in FIG. 15d the loading aid 18 is transported away from the receiving location 44 by the conveying system 45.

In addition, 16a to 16d show the handover (loading operation) of a (empty) loading aid 18 from the receiving location 44 onto the transport vehicle 1. For the transfer of the loading aid 18, the transport vehicle 1 is again positioned at the parking location 46 in such a way that its loading platform 5 is aligned with the receiving location 44.

In the case shown in FIG. 16a to 16d, the pusher 50 is in its starting position or in a position at the lower edge of the loading platform 5 of the transport vehicle 1 the whole time. In FIG. 16a the loading aid 18 is transported by the conveying system 45 towards the receiving location 44 and in FIG. 16b has arrived there. The loading aid 18 is, however, conveyed by the conveying system 45 beyond the receiving location 44 onto the loading platform 5 of the transport vehicle 1, as is shown in FIG. 16c. Stopping at the receiving location 44 is not necessary, but it is possible. In the state shown in FIG. 16d, the loading aid 18 has already been transported so far to the right that it has tipped from the receiving location 44 onto the loading platform 5 and has slid up to and been stopped by the first stop element 7.

Alternatively or in addition, when pushing over the loading platform 5 the loading aid 18 can be stopped or secured by the pusher 50 so that it cannot fall off the loading platform 5. It would also be conceivable for the loading aid 18 to be held by the pusher 50 and allowed to slide in a controlled manner up to the stop element 7, wherein the pusher 50 moves to the right. Finally, it would also be conceivable for the pushing of the loading aid 18 from the receiving location 44 onto the loading platform 5 to be performed using the pusher 50. The conveying system 45 does not have to be driven for that purpose.

The handover station 43, 43′ was explained in connection with a transport vehicle 1 of the second conveying system 17, although its use in connection with a transport vehicle 35 of the third conveying system 34 in the same manner is also fundamentally imaginable.

An advantageous embodiment of an order-picking system for picking articles 12 can now comprise
a storage zone 32 in which storage places for providing the articles 12 are arranged,
a picking zone in which a workstation 11 for loading target loading aids 18 with articles 12 is arranged,
a first conveying system 16 for transporting the articles 12,
wherein the transportation of the articles 12 by the first conveying system 16 comprises a transportation of the articles 12 from a transfer zone F to a first provisioning device 15 at the workstation 11,
a second conveying system 17 for transporting the target loading aids 18 comprising driverless transport vehicles 1,
wherein the transportation of the target loading aids 18 by the driverless transport vehicles 1
comprises a transportation of the (empty) target loading aids 18 from a handover station 43, 43′, in particular a handover station 43, 43′ of one of the aforementioned types, to a second provisioning device 21 at the workstation 11, and
comprises a transportation of the (loaded) target loading aids 18 from the workstation 11 to a handover station 43′, in particular a handover station 43 of one of the aforementioned types, and
a handover station 43, 43′ for transferring a (empty) target loading aid 18 from a receiving location 44 of the handover station 43, 43′ onto a loading platform 5 of a driverless transport vehicle 1,
a handover station 43 for transferring a (loaded) target loading aid 18 from a loading platform 5 of a driverless transport vehicle 1 onto a receiving location 44 of the handover station 43,
wherein at least one of the handover stations is provided by the handover station 43 of one of the aforementioned types.

The workstation 11 can thereby also be configured according to one of the aforementioned types.

Finally, it should be noted that the scope of protection is defined by the claims. However, the description and the drawings should be consulted when construing the claims. Individual features or combinations of features from the various example embodiments as shown and described can constitute separate inventive solutions. The problem to be solved by the individual inventive solutions can be derived from the description.

In particular, it should be noted that in reality the represented devices can comprise more or fewer components than shown. The represented devices and their components can partially also be shown not to scale and/or in magnification and/or shrunk down.
1 Driverless transport vehicle (of second conveying system)
2, 2′ Support frame
3,3′ Chassis (wheel of which visible)
4,4′ Controller
5,5′ Loading platform
6 Base
7 First stop element
8 Second stop element
9 Third stop element
10 Sliding support
11 Workstation
12 Article
13 Loading aid (of first conveying system) / source loading aid
14 Order management system
15 First provisioning device
16 First conveying system
17 Second conveying system
18 Loading aid (of second conveying system) / target loading aid
19 First driving surface
20 Second driving surface
21 Second provisioning device
22 Third driving surface
23 Control unit
24 Input and/or output device
25 First lane first driving surface section
26 Second lane second driving surface section
27 Changeover lane
28a Approaching lane
28b Returning lane
28c Provisioning lane
30 Sorting lane
31 Order-picking system
32 Storage zone
34 Third conveying system
35 Transport vehicles of third conveying system
36 Transfer station
37 First transfer location
38 First transfer device
39 Second transfer location
40 Second transfer device
41 Transfer device assigned to the transport vehicle
42 Lifting device
43, 43′ Handover station
44 Receiving location
45 Conveying system
46 Parking location
47 Transfer device
48 Drive device
49 Guide
50 Pusher
51 Carriage
52 Traction drive
53 Guide roller
54 Positioning system
55 Driving path
56 Positioning element
57 Stop profile
58 Stop element
α Angle of inclination loading platform transport vehicle
β Angle of inclination guide transfer device
a1 Clearance height first driving surface section
a2 Clearance height second driving surface section
b1 Clearance width first driving surface section
b2 Clearance width second driving surface section
A Front vehicle side
AP Working location
B Rear vehicle side
C Driving direction
D Longitudinal axis
E Handover section
F Transfer zone
G First provisioning position
H First driving surface section first driving surface
I Second driving surface section first driving surface
J Second provisioning position
K Passageway
L Additional passageway
M Coupling zone first driving surface section
N Coupling zone second driving surface section
O First driving surface section third driving surface
P Second driving surface section third driving surface
Q Driving surface section second driving surface
R Third driving surface section third driving surface
S Third driving surface section first driving surface
T Passageway handover station
U Entry zone
V Exit zone
W Stop surface

1. A driverless transport vehicle (1), in particular for transporting a loading aid (18), comprising
a support frame (2),
a chassis (3) mounted on the support frame (2), the chassis (3) comprising a plurality of wheels and being configured to drive and steer the driverless transport vehicle (1),
a controller (4) configured to receive drive commands and to control the driverless transport vehicle (1), and
a loading platform (5) mounted on the support frame (2), wherein
the loading platform (5) comprises a base (6) permanently fixed on the support frame (2) and inclined by an angle of inclination (α) in relation to a horizontal plane.

2. The driverless transport vehicle (1) according to claim 1, wherein the support frame (2) comprises a front vehicle side (A) and a rear vehicle side (B) and the base (6) is laterally inclined by the angle of inclination (α) in relation to a longitudinal axis (D) extending between the front vehicle side (A) and the rear vehicle side (B).

3. The driverless transport vehicle (1) according to claim 1, wherein the support frame (2) comprises a front vehicle side (A) and a rear vehicle side (B) and the base (6) is inclined forwards or rearwards by the angle of inclination (α) in the direction of a longitudinal axis (D) extending between the front vehicle side (A) and the rear vehicle side (B).

4. The driverless transport vehicle (1) according to claim 1, wherein the angle of inclination (α) of the base (6) is in a range of 10° to 60°.

5. The driverless transport vehicle (1) according to claim 1, wherein the loading platform (5) additionally comprises
a first stop element (7) arranged in a lower-lying side region of the base (6) and protruding in relation to the base (6), and
a handover section (E) arranged in a higher-lying side region of the base (6).

6. The driverless transport vehicle (1) according to claim 5, wherein the loading platform (5) additionally comprises
a second stop element (8) arranged in a side region of the base (6) extending between the lower-lying side region of the base (6) and the higher-lying side region of the base (6) and protruding in relation to the base (6), and
a third stop element (9) arranged in a side region of the base (6) extending between the lower-lying side region of the base (6) and the higher-lying side region of the base (6) and protruding in relation to the base (6).

7. The driverless transport vehicle (1) according to claim 5, wherein the loading platform (5) additionally comprises
a sliding support (10) arranged in the higher-lying side region of the base (6) forming the handover section (E).

8. The driverless transport vehicle (1) according to claim 1, wherein the base (6) comprises a base plate.

9. The driverless transport vehicle (1) according to claim 1, wherein the base (6) comprises support profiles.

10. The driverless transport vehicle (1) according to any claim 1, wherein the base (6) forms a sliding plane.

11. The driverless transport vehicle (1) according to claim 10, wherein the sliding plane stretches between the handover section (E) and the first stop element (7) and optionally between the second stop element (8) and the third stop element (9).

12. A workstation (11) for loading loading aids (18) with articles (12) according to orders, in particular picking orders, comprising
an order management system (14) for the electronic acquisition of orders,
a first provisioning device (15) for providing articles (12) at a first provisioning position (G),
a first conveying system (16) connecting a transfer zone (F) and the first provisioning device (15) and configured to transport the articles (12) between the transfer zone (F) and the first provisioning device (15),
a second conveying system (17) comprising driverless transport vehicles (1) for transporting the loading aids (18),
a first driving surface (19) comprising a first driving surface section (H) and a second driving surface section (1),
a second driving surface (20) comprising a second provisioning device (21) for providing loading aids (18) with the driverless transport vehicles (1) at a second provisioning position (J),
a third driving surface (22) arranged between the first driving surface (19) and the second driving surface (20),
wherein the first conveying system (16) in a conveying section facing the first provisioning device (15) and the second driving surface (20) are each arranged with a vertical spacing to the first driving surface (19), and a passageway (K) is arranged below the first conveying system (16) and the second driving surface (20), along which passageway (K) the first driving surface section (H) extends and which has a clearance height (a1) that enables a collision-free movement of the transport vehicles (1) each loaded with a loading aid (18), and
a control unit (23) for controlling the first conveying system (16) and the transport vehicles (1) in such a way that an article (12) transported by the first conveying system

(16) and a loading aid (18) transported by one of the transport vehicles (1), of an order arrive approximately simultaneously at the first and second provisioning positions (G, J), whereupon the loading aid (18) can be loaded with the article (12).

13. The workstation (11) according to claim 12, wherein the first conveying system (16) is arranged in a conveying section facing away from the first provisioning device (15) at a vertical spacing to the first driving surface (19) and an additional passageway (L) is arranged below the first conveying system (16), along which the second driving surface section (I) extends and which has a clearance height (a2) that enables a collision-free movement of the transport vehicles (1) each loaded with a loading aid (18).

14. The workstation (11) according to claim 12, wherein each of the transport vehicles (1) comprises
a support frame (2),
a chassis (3) mounted on the support frame (2), the chassis (3) comprising a plurality of wheels and being configured to drive and steer the driverless transport vehicle (1),
a controller (4) configured to receive drive commands and to control the driverless transport vehicle (1), and
a loading platform (5) mounted on the support frame (2), wherein
the loading platform (5) comprises a base (6) permanently fixed on the support frame (2) and inclined by an angle of inclination (α) in relation to a horizontal plane.

15. The workstation (11) according to claim 12, wherein the transfer zone (F) is configured
to transfer articles (12) to the first conveying system (16), or
to transfer articles (12) to the first conveying system (16) and to transfer articles (12) from the first conveying system (16).

16. The workstation (11) according to claim 12, wherein a first lane (25) extends along the first driving surface section (H) and a second lane (26) extends along the second driving surface section (I).

17. The workstation (11) according to claim 16, wherein a changeover lane (27) extends between the first lane (25) and the second lane (26) and the transport vehicles (1) are moved on the first driving surface (19) between the first driving surface section (H) and the second driving surface section (I).

18. The workstation (11) according to claim 16, wherein
an approaching lane (28a) diverges from the second lane (26) and a returning lane (28b) merges into the second lane (26),
the approaching lane (28a) extends in a first driving surface section (O) of the third driving surface (22),
the returning lane (28b) extends in a second driving surface section (P) of the third driving surface (22), and
a provisioning lane (28c) extends between the approaching lane (28a) and the returning lane (28b) in a driving surface section (Q) of the second driving surface (20), wherein the provisioning lane (28c) is assigned to the second provisioning device (21).

19. The workstation (11) according to claim 18, wherein the approaching lane (28a) and the returning lane (28b) extend in parallel and the transport vehicles (1) are moved in a single direction along the approaching lane (28a), provisioning lane (28c) and returning lane (28b).

20. The workstation (11) according to claim 18, wherein one or more sorting lanes (30) extend between the approaching lane (28a) and the returning lane (28b) in a third driving surface section (R) of the third driving surface (22).

21. The workstation (11) according to claim 18, wherein one or more express lanes (29) extend between the approaching lane (28a) and the returning lane (28b) in the driving surface section (Q) of the second driving surface (20).

22. The workstation (11) according to claim 16, wherein
the first lane (25) extending in the first driving surface section (H) and the second lane (26) extending in the second driving surface section (I) each have a coupling zone (M, N),
wherein the workstation (11) is connectable by the coupling zones (M, N) with a further workstation (11), in particular with an identical construction, adjacent to the workstation (11).

23. The workstation (11) according to claim 12, wherein the control unit (23) is additionally configured to control the first conveying system (16) and the transport vehicles (1) in such a way that the transport vehicles sort the loading aids (18) into an order determined depending on the order in which the articles (12) are provided at the first provisioning device (15), and wherein a loading aid (18) and an article (12) of an order arrive approximately simultaneously at the first provisioning position (G) and the second provisioning position (J).

24. The workstation (11) according to claim 20, wherein
an order of the orders comprises a first order line and a second order line, wherein the first order line and second order line comprise articles (12) of different article types, and the control unit (23) is additionally configured such that
a loading aid (18) for processing the first and second order lines after loading of the loading aid (18) with the article (12) of the first order line is transported by the transport vehicle (1) from the second provisioning device (21) via the returning lane (28b) into a sorting lane (30) and is buffered in the sorting lane (30), and thereafter the loading aid (18) is transported from the sorting lane (30) via the approaching lane (28a) to the second provisioning device (21) when the article (12) of the second order line is transported to the first provisioning device (15) by the first conveying device (16).

25. The workstation (11) according to claim 12, wherein
a plurality of orders comprise articles (12) of the same article type,
a loading aid (18) is assigned to each order, and
the control unit (23) is additionally configured to control the loading of each of the loading aids (18) assigned to the orders with an article (12) of the same article type,
wherein the article (12) is provided once at the first provisioning device (15) and the loading aids (18) are provided at the second provisioning device (21) on one transport vehicle (1) each.

26. : The workstation (11) according to claim 12, wherein the first conveying system (16) comprises a plurality of buffer locations and the control unit (23) is additionally configured to provide an article (12) of a different article type one after the other, wherein the article (12) is buffered at the buffer locations.

27. The workstation (11) according to claim 12, wherein
the transport vehicle (1) comprises a support frame (2), a chassis (3) mounted on the support frame (2), the chassis (3) comprising a plurality of wheels and being configured to drive and steer the driverless transport vehicle (1), a controller (4) configured to receive drive commands and to control the driverless transport vehicle (1), and a loading platform (5) mounted on the support frame (2), wherein the loading platform (5) comprises a base (6) permanently fixed on the support frame (2) and inclined by an angle of inclination (α) in relation to a horizontal plane,
a loading aid (18) is placeable on the base (6) of the loading platform (5), said base being inclined by an angle of inclination (α) in relation to a horizontal plane,
the loading aid (18) comprises a base, side walls projecting from the base, and a loading opening delimited by the side walls, and
the controller (4) of the transport vehicle (1) performs a drive command in such a way that the transport vehicle (1) is provided at the second provisioning device (21) in a pose in which that loading aid (18) is aligned in such a way to the first provisioning device (15) that an edge of a front side wall of the side walls is positioned lower than an edge of a rear side wall of the side walls in order to enable ergonomic loading of the loading aid (18) with the article (12) via the loading opening.

28. An order-picking system (31) for picking articles (12), comprising
a storage zone (32) in which storage places for providing articles (12) are arranged, and
a picking zone for processing orders in which at least one workstation (11) according to claim 12 is arranged.

29. The order-picking system (31) according to claim 28, wherein the order-picking system (31) further comprises
a third conveying system (34) connecting the storage zone (32) and the transfer zone (F) and comprising driverless transport vehicles (35) for transporting articles (12) between the storage zone (32) and the transfer zone (F).

30. The order-picking system (31) according to claim 29, wherein
the first driving surface (19) additionally comprises a third driving surface section (S) arranged between the storage zone (32) and the transfer zone (F), and
the driverless transport vehicles (35) of the third conveying system (34) move in the third driving surface section(S).

31. The order-picking system (31) according to claim 29, wherein
the first driving surface (19) additionally comprises a third driving surface section (S) arranged between the storage zone (32) and the transfer zone (F), and
the driverless transport vehicles (35) of the third conveying system (34) move in the third driving surface section(S) and move to the storage places in the storage zone (32).

32. The order-picking system (31) according to claim 28, wherein
the driverless transport vehicles (35) move exclusively in the storage zone (32),
the storage zone (32) and the transfer zone (F) are arranged in such a way that
the articles (12) are transferred directly from the storage zone (32) to the first conveying system (16), or
the articles (12) are transferred directly from the storage zone (32) to the first conveying system (16) and the articles (12) are transferred directly from the first conveying system (16) to the storage zone (32).

33. The order-picking system (31) according to claim 28, wherein the workstation (11) in the transfer zone (F) has a transfer station (36), wherein the transfer station (36) comprises
a first transfer location (37) and a first transfer device (38) assigned to the first transfer location (37), wherein the first transfer location (37) is configured to receive an article (12) and wherein the first transfer device (38) is configured to transfer the article (12) from the first transfer location (37) to the first conveying system (16), and/or
a second transfer location (39) and a second transfer device (40) assigned to the second transfer location (39), wherein the second transfer location (39) is configured to receive an article (12) and wherein the second transfer device (40) is configured to transfer the article (12) from the first conveying system (16) to the second transfer location (39).

34. The order-picking system (31) according to claim 28, wherein the workstation (11) in the transfer zone (F) has a transfer station (36), wherein the transfer station (36) comprises
a first transfer location (37) configured to receive a transport vehicle (35) of the third conveying system (34) with the article (12), and a transfer device (41) assigned to the transport vehicle (35), wherein the transfer device (41) is configured to transfer the article (12) from the transport vehicle (35) to the first conveying system (16), and/or
a second transfer location (39) configured to receive a transport vehicle (35) of the third conveying system (34), and a transfer device (41) assigned to the transport vehicle (35), wherein the transfer device (41) is configured to transfer the article (12) from the first conveying system (16) to the transport vehicle (35).

35. The order-picking system (31) according to any one claim 28, wherein the transfer station (36) comprises a lifting device (42) assigned to the first conveying system (16), on which lifting device the article (12) or the transport vehicle (35) is receivable.

36. The order-picking system (31) according to claim 28, wherein the driverless transport vehicles (1) of the second conveying system (17) and the driverless transport vehicles (35) of the third conveying system (34) have different structural configurations.

37. The order-picking system (31) according to claim 29, wherein the driverless transport vehicles (35), in particular for transporting an article (12), of the third conveying system (34) each comprise
a support frame (2′),
a chassis (3′) mounted on the support frame (2′), the chassis (3′) comprising a plurality of wheels and being configured to drive and optionally to steer the driverless transport vehicle (35),
a controller (4′) configured to receive drive commands and to control the driverless transport vehicle (35), and
a loading platform (5′) mounted on the support frame (2′), comprising a horizontally aligned base, in particular permanently fixed on the support frame (2′) or arranged on a lifting device.

38. A handover station (43, 43′) for automatically transferring a loading aid (18) between the loading platform (5) of a driverless transport vehicle (1) and a receiving location in particular on a conveying system (45), comprising
the driverless transport vehicle (1) according to claim 1,
a parking location (46) for the driverless transport vehicle (1), at which the driverless transport vehicle (1) is positionable in such a way that the loading platform (5) of the driverless transport vehicle (1) is aligned with the receiving location (44),
a transfer device (47) with a pusher (50) movable relative to the receiving location (44) and along a guide (49) by a drive device (48), the pusher (50) being configured to push a loading aid (18) from the loading platform (5) of the driverless transport vehicle (1) onto the receiving location (44) and/or to push a loading aid (18) from the receiving location (44) onto the loading platform (5) of the driverless transport vehicle (1) when the loading platform (5) of the driverless transport vehicle (1) is aligned with the receiving location

39. The handover station (43, 43′) according to claim 38, wherein the guide (49) forms a guide plane inclined by an angle of inclination (β) in relation to a horizontal plane, the guide plane extending substantially parallel to the base (6) of the loading platform (5).

40. The handover station (43, 43′) according to claim 38, wherein the drive device (48) comprises a carriage (51) and a traction drive (52), wherein the carriage (51) is coupled with the traction drive (52) and is mounted to the guide (49) using guide rollers (53), and wherein the pusher (50) is mounted on the carriage (51).

41. The handover station (43, 43′) according to any claim 38, wherein the handover station (43, 43′) additionally comprises
a conveying system (45) for transporting the loading aid (18) away from the receiving location (44) and/or for transporting the loading aid (18) to the receiving location

42. The handover station (43, 43′) according to any claim 38, wherein the handover station (43, 43′) additionally comprises
a positioning system (54) for positioning the driverless transport vehicle (1) relative to the parking location (46).

43. The handover station (43, 43′) according to any claim 38, wherein the handover station (43, 43′) additionally comprises
a passageway (T) forming an entry zone (U), an exit zone (V) and a driving path (55) extending between the entry zone (U) and the exit zone (V),
wherein the parking location (46) is arranged along the driving path (55) and the driverless transport vehicle (1) can enter the handover station (43, 43′) in the entry zone (U) and exit the handover station (43, 43′) in the exit zone (V).

44. The handover station (43, 43′) according to claim 43, wherein the positioning system (54) comprises positioning elements (56) on both sides of the driving path (55) and symmetrically to a vertical plane in the direction of the driving path (55).

45. The handover station (43, 43′) according to claim 44, wherein the positioning elements (56) each comprise a stop profile (57) and the stop profiles (57) form a stop surface (W) on their side walls facing each other, wherein the stop surface (W) can interact with a support frame (2) of the driverless transport vehicle (1) when the driverless transport vehicle (1) is provided at the parking location (46) and a loading aid (18) is pushed from the loading platform

(5) of the driverless transport vehicle (1) onto the receiving location (44) and/or a loading aid (18) is pushed from the receiving location (44) onto the loading platform (5) of the driverless transport vehicle (1).

46. An order-picking system (31) for picking articles (12), comprising
a storage zone (32) in which storage places for providing articles (12) are arranged,
a picking zone in which a workstation (11) for loading loading aids (18) with articles (12) is arranged,
a first conveying system (16) for transporting the articles (12),
wherein the transportation of the articles (12) by the first conveying system (16) comprises a transportation of the articles (12) from a transfer zone (F) to a first provisioning device (15) at the workstation (11),
a second conveying system (17) for transporting the loading aids (18) and comprising driverless transport vehicles (1),
wherein the transportation of the loading aids (18) by the driverless transport vehicles (1)
comprises a transportation of the loading aids (18) from a handover station (43, 43′), in particular according to claim 38, to a second provisioning device (21) at the workstation (11), and
comprises a transportation of the loading aids (18) from the workstation (11) to a handover station (43),
a handover station (43, 43′) for transferring a loading aid (18) from a receiving location (44) of the handover station (43, 43′) onto a loading platform (5) of a driverless transport vehicle (1), and
a handover station (43) for transferring a loading aid (18) from a loading platform

(5) of a driverless transport vehicle (1) onto a receiving location (44) of the handover station (43),
wherein at least one of the handover stations (43, 43′) (43, comprises
a driverless transport vehicle (1) comprising a support frame (2), a chassis (3) mounted on the support frame (2), the chassis (3) comprising a plurality of wheels and being configured to drive and steer the driverless transport vehicle (1), a controller (4) configured to receive drive commands and to control the driverless transport vehicle (1), and a loading platform (5) mounted on the support frame (2), wherein the loading platform (5) comprises a base (6) permanently fixed on the support frame (2) and inclined by an angle of inclination (α) in relation to a horizontal plane,
a parking location (46) for the driverless transport vehicle (1), at which the driverless transport vehicle (1) is positionable in such a way that the loading platform (5) of the driverless transport vehicle (1) is aligned with the receiving location (44),
a transfer device (47) with a pusher (50) movable relative to the receiving location (44) and along a guide (49) by a drive device (48), the pusher (50) being configured to push a loading aid (18) from the loading platform (5) of the driverless transport vehicle (1) onto the receiving location (44) and/or to push a loading aid (18) from the receiving location (44) onto the loading platform (5) of the driverless transport vehicle (1) when the loading platform (5) of the driverless transport vehicle (1) is aligned with the receiving location

47. The order-picking system (31) according to claim 46, wherein the workstation (11) comprises
an order management system (14) for the electronic acquisition of orders,
a first provisioning device (15) for providing articles (12) at a first provisioning position (G),
a first conveying system (16) connecting a transfer zone (F) and the first provisioning device (15) and configured to transport the articles (12) between the transfer zone (F) and the first provisioning device (15),
a second conveying system (17) comprising driverless transport vehicles (1) for transporting the loading aids (18),
a first driving surface (19) comprising a first driving surface section (H) and a second driving surface section (I),
a second driving surface (20) comprising a second provisioning device (21) for providing loading aids (18) with the driverless transport vehicles (1) at a second provisioning position (J),
a third driving surface (22) arranged between the first driving surface (19) and the second driving surface (20),
wherein the first conveying system (16) in a conveying section facing the first provisioning device (15) and the second driving surface (20) are each arranged with a vertical spacing to the first driving surface (19), and a passageway (K) is arranged below the first conveying system (16) and the second driving surface (20), along which passageway (K) the first driving surface section (H) extends and which has a clearance height (a1) that enables a collision-free movement of the transport vehicles (1) each loaded with a loading aid (18), and
a control unit (23) for controlling the first conveying system (16) and the transport vehicles (1) in such a way that an article (12) transported by the first conveying system

(16) and a loading aid (18) transported by one of the transport vehicles (1), of an order arrive approximately simultaneously at the first and second provisioning positions (G, J), whereupon the loading aid (18) can be loaded with the article (12).

48. A method for loading loading aids (18) with articles (12) according to orders, in particular picking orders, at a workstation (11) according to claim 12, in which
the first conveying system (16) and the transport vehicles (1) are controlled by the control unit (23) in such a way that an article (12) transported by the first conveying system (16), and a loading aid (18) transported by one of the transport vehicles (1), of an order arrive approximately simultaneously at the first and second provisioning positions (G, J),
wherein a loading aid (18) is placed on the base (6) of the loading platform (5), the base being inclined by an angle of inclination (α) in relation to a horizontal plane,
wherein the loading aid (18) comprises a base, side walls projecting from the base, and a loading opening delimited by the side walls, and
wherein the controller (4) of the transport vehicle (1) performs a drive command in such a way that the transport vehicle (1) is provided at the second provisioning device

(21) in a pose in which the loading aid (18) is aligned in such a way to the first provisioning device (15) that an edge of a front side wall of the side walls is positioned lower than an edge of a rear side wall of the side walls in order to enable ergonomic loading of the loading aid (18) with the article (12) via the loading opening.
